(19) United States
(12) Patent Application Publication
(10) Pub. No.: US 2025/0092260 A1
(43) Pub. Date: Mar. 20, 2025

(54) URETHANE-MODIFIED COLD MIX ASPHALT REPAIR COMPOSITION AND METHOD OF MAKING

(71) Applicant: United States of America as Represented by The Secretary of The Army, Alexandria, VA (US)

(72) Inventors: Benjamin C. Cox, Clinton, MS (US); Sadie E. Casillas, Vicksburg, MS (US)

(73) Assignee: United States of America as Represented by The Secretary of The Army, Alexandria, VA (US)

(21) Appl. No.: 18/664,265

(22) Filed: May 14, 2024

Related U.S. Application Data
(60) Provisional application No. 63/466,418, filed on May 15, 2023.

(51) Int. Cl. C08L 95/00

(52) U.S. Cl. CPC C08L 95/00; C08L 2555/28; C08L 2555/80

(57) ABSTRACT

In one embodiment, a cold mix asphalt composition comprises an aggregate blend including an aggregate and a filler; and a cold mix asphalt binder including a urethane-modified asphalt binder mixed with the aggregate blend to form the cold mix asphalt composition.

### CROSS-REFERENCE TO RELATED APPLICATIONS

This is a nonprovisional application that claims the benefit of priority from U.S. Provisional Application No. 63/466,418 entitled “Urethane-Modified Cold Mix Asphalt Repair Compositions and Methods of Making,” filed on May 15, 2023, the disclosure of which is incorporated herein by reference in its entirety.

### STATEMENT OF GOVERNMENT INTEREST

Under paragraph 1(a) of Executive Order 10096, the conditions under which this invention was made entitle the Government of the United States, as represented by the Secretary of the Army, to an undivided interest therein on any patent granted thereon by the United States. This and related patents are available for licensing to qualified licensees.

### BACKGROUND

### Field of the Invention

The present invention relates to asphalt repair and, more specifically, to cold mix asphalt repair compositions and methods.

### Description of the Related Art

This section introduces aspects that may help facilitate a better understanding of the invention. Accordingly, the statements of this section are to be read in this light and are not to be understood as admissions about what is prior art or what is not prior art.

Asphalt pavement refers to any paved road surfaced with asphalt. Traditional asphalt patching materials consist of either cold mix asphalt (CMA) or hot mix asphalt (HMA).

Hot mix asphalt is a composite material composed of aggregates, asphalt binder, and fillers heated and mixed in a plant to create an asphalt mixture. The mixture is then placed into storage silos and transported to the construction site, where it is laid on roads or parking lots using specialized equipment. An aggregate blend combines sand and gravel, rocks, and other materials, creating a solid mixture that can withstand heavy loads and low temperatures. The size of these aggregates also affects the quality of the asphalt, with smaller particles providing an improved ability to hold together during compaction. A binder is a thin film of asphalt cement that coats the aggregate between the particles. It acts as an adhesive for the particles, ensuring the asphalt mixture does not break apart when exposed to pressure or movement. Furthermore, it helps protect the mixture from water damage, improving the resistance of the asphalt mixture against wear and tear from weather exposure. Additives are an integral component of hot-mix asphalt. These materials are added during the asphalt binder production or asphalt mixing process to improve the asphalt's durability and performance. Common additives include polymers, fibers, and waxes, which can modify rheology and viscosity on the molecular level; antistripping agents, which can reduce moisture absorption properties and help protect against damage caused by wear and oxidation; and softening agents to reduce stiffness and enhance elasticity. The aggregates are typically dried and heated to high temperatures before being combined with an asphalt binder. Asphalt binder is a product of petroleum refining which can then be modified and mixed with the desired additives as mentioned above, such as polymers. Asphalt binder is heated prior to asphalt production to ensure the binder viscosity is low enough to facilitate thorough and uniform mixing with the heated aggregate blend. Once the aggregate blend, asphalt binder, and filler have been mixed to produce the asphalt mixture, temperature is controlled within specification requirements to maintain the optimal state for construction, including placement and compaction.

Cold mix asphalt is a material that is made up of a combination of emulsified or cutback asphalts and aggregate. It does not require heating and can be applied to the surface at ambient temperatures without the use of heavy equipment. Conventional cold mix asphalt provides marginal performance, particularly when under heavy load, and requires a curing period yet is generally less durable and rut resistant than hot mix asphalt.

### SUMMARY

Military and civilian runways, roadways, or other asphalt pavements can incur sudden damage or deteriorate over time, resulting in potholes, fissures, or other surface irregularities. Repairs of asphalt pavements may be needed rapidly to ensure that operations are not disrupted; however, ideal materials and equipment may not be available in these scenarios. Additionally, such repairs must be of a quality that can support anticipated traffic loading, which can be extreme particularly in military environments, within about 2 to 4 hours after the repair is completed and the composition is installed.

The invention provides a material composition which can be readily deployed to provide efficient performance. To minimize disruption to users, these distresses or defects require patching or repair. An embodiment of the invention provides a cold mix asphalt patching material composition which can be stored in remote locations, rapidly deployed for repair, support traffic quickly after the repair, and provide efficient performance under traffic loading. The high-performance cold mix asphalt for patching asphalt and other surfaces has a composition that is easily installed, is usable within about 2-4 hours of installation, and can withstand high loading conditions over an extended period of time.

Embodiments of the invention provide a unique urethane-modified asphalt binder cold mix asphalt having the logistical advantages of conventional cold mix asphalt and the performance and durability advantages of hot mix asphalt for patching asphalt and other surfaces. The high-performance cold mix asphalt can be used and deployed soon after application. The novel composition can be field mixed with no special equipment and provides a highly elastic, durable surface in a short timeframe that exhibits little temperature sensitivity. The novel methods and compositions provide durable, stable, and logistically advantageous solutions to surface repair not currently available or usable in both civilian and military settings.

In specific embodiments, unique compositions and methods provide a cold mix asphalt that can be field mixed using no special equipment and provide a highly elastic, durable surface in a short timeframe that exhibits little temperature sensitivity and extended usability under repeated high loading conditions. The compositions and methods can be used in any number of applications, namely military applications such as airfield and roadway patching maintenance and repair, airfield damage repair, and contingency operation repair, as well as civilian and commercial applications such as airfield and roadway patching maintenance and repair, and repair of private pavements such as private or public parking lots and business and homeowner driveways, for example.

For asphalt patching materials, three key metrics are used to evaluate performance: 1) rapid repair times, 2) rapid return to traffic, and 3) proven performance. Typical CMA can provide rapid repair but not rapid return to traffic or adequate performance. CMA utilizes either cutback asphalts or asphalt emulsions for the asphalt binder. Both of these materials require a curing time after placement in order to yield the ultimate structural capacity required and therefore cannot support rapid return to traffic. Typical HMA, however, satisfies rapid return to traffic and proven performance, but is not typically available outside of paving season (i.e., summer months) and requires close proximity to an asphalt plant to access and place while still hot. If HMA is not placed immediately after being taken from an asphalt plant, the HMA material requires reheating to become workable for placement.

According to an aspect the present invention, a cold mix asphalt composition comprises an aggregate blend including an aggregate and a filler; and a cold mix asphalt binder including a urethane-modified asphalt binder mixed with the aggregate blend to form the cold mix asphalt composition.

In some embodiments, the urethane-modified asphalt binder comprises Blackhawk 5700 (BH5700) asphalt-modified polyurethane. The urethane-modified asphalt binder and the aggregate blend are mixed to form a two-part binder and aggregate blend, including a Part A portion as a first portion of the two-part binder to be mixed with the aggregate blend initially and a Part B portion as a second portion of the two-part binder to be mixed with an initial mixture of the Part A portion and the aggregate blend subsequently.

In specific embodiments, the Part A portion and the aggregate blend are mixed to form a shelf stable mixture in preset proportions between the Part A portion and the aggregate blend to yield a quantity to be stored. The Part A portion is about 1-10% by a total weight of the quantity and the aggregate blend is about 90-99% by the total weight. The Part B portion comprises a Part B activator dosed at approximately 2-5% by a total weight of both the Part A portion and the Part B portion combined, and the Part A portion comprises a Part A binder dosed at approximately 95-98% by the total weight.

In accordance with another aspect of the invention, a method of producing a cold mix asphalt comprises: mixing an aggregate blend, including an aggregate and a filler, and a cold mix asphalt binder including a urethane-modified asphalt binder to form a cold mix asphalt composition; applying the cold mix asphalt composition to a surface; and compacting the cold mix asphalt composition.

In some embodiments, mixing the aggregate blend and the cold mix asphalt binder comprises mixing the aggregate blend and the Part A portion of the two-part binder initially to form an initial mixture; and mixing the initial mixture and the Part B portion of the two-part binder subsequently to form the cold mix asphalt composition. The initial mixture is formed by mixing the Part A portion off-site away from a location of the surface for applying and compacting the cold mix asphalt composition. The cold mix asphalt composition is formed by mixing the Part B portion on-site at the location of the surface for applying and compacting the cold mix asphalt composition. The initial mixture is formed by mixing the Part A portion with the aggregate blend for about 3-4 minutes. The cold mix asphalt composition is formed by mixing the Part B portion with the initial mixture for at least about 3 minutes.

In accordance with another aspect of the invention, a cold mix asphalt composition comprises an aggregate blend including an aggregate and a filler; and a two-part binder mixed with the aggregate blend to form the cold mix asphalt composition. The two-part binder includes a urethane-modified asphalt binder as a Part A binder to be mixed with the aggregate blend to form an initial mixture, and an asphalt-modified polyurethane as a Part B activator to be mixed with the initial mixture to form the cold mix asphalt composition.

In specific embodiments, the urethane-modified asphalt binder is the asphalt-modified polyurethane. The Part A binder and the Part B activator are preset proportions of the asphalt-modified polyurethane. The Part A binder may be dosed at approximately 95 to 98% by a total weight of the Part A binder and the Part B activator, and the Part B activator may be dosed at approximately 2 to 5% by the total weight of the Part A binder and the Part B activator.

### BRIEF DESCRIPTION OF THE DRAWINGS

Embodiments of the invention will become more fully apparent from the following detailed description, the appended claims, and the accompanying drawings in which like reference numerals identify similar or identical elements.

FIG. 1 is a Table of the properties of mineral aggregates.

FIG. 2 shows a graphical plot illustrating the coarse and the fine gradations tested.

FIG. 3 is a Table of the properties of COTS CMA control mixtures.

FIG. 4 is a Table of the mix design properties of HMA control mixtures.

FIG. 5 is a Table summarizing the laboratory experimental plan utilized in this project.

FIG. 6 portrays a diagram of the field testing layout at the U.S. Army Engineer Research and Development Center (ERDC) outdoor pavements test facility.

FIG. 7 is a graphical plot illustrating curing profiles for CPB C₁ and F₁ mixes.

FIG. 8 is a Table showing a summary of balanced mix design properties for lab-designed CMA.

FIG. 9 is a graphical plot of the number of APA (Asphalt Pavement Analyzer) cycles to 10 mm rut for CMA balanced mix design.

FIG. 10 is a graphical plot of the number of Hamburg passes to 12.5 mm rut for CMA balanced mix design.

FIG. 11 is a graphical plot of Hamburg stripping inflection points for CMA balanced mix design.

FIG. 12 is a graph of CML (Cantabro Mass Loss) for CMA balanced mix design.

FIG. 13 is a graphical diagram illustrating IDT (Indirect Tensile) results for CMA balanced mix design for (A) IDT St results and (B) IDT fracture energy results.

FIG. 14 shows mix design volumetric charts of C₁ for (A) Vₐ versus Binder Content, (B) VMA versus Binder Content, (C) VFA (Voids Filled Asphalt) versus Binder Content, and (D) Dust to Binder Ratio versus Binder Content.

FIG. 15 shows mix design volumetric charts of F₁ for (A) Vₐ versus Binder Content, (B) VMA versus Binder Content, (C) VFA (Voids Filled Asphalt) versus Binder Content, and (D) Dust to Binder Ratio versus Binder Content.

FIG. 16 shows mix design volumetric charts of C₂ for (A) Vₐ versus Binder Content, (B) VMA versus Binder Content, (C) VFA (Voids Filled Asphalt) versus Binder Content, and (D) Dust to Binder Ratio versus Binder Content.

FIG. 17 shows mix design volumetric charts of F₂ for (A) Vₐ versus Binder Content, (B) VMA versus Binder Content, (C) VFA (Voids Filled Asphalt) versus Binder Content, and (D) Dust to Binder Ratio versus Binder Content.

FIG. 18 is a Table of summary of properties for lab-designed CMA and control mixes.

FIG. 19 presents CML (Cantabro Mass Loss) data for mixes in the Table of FIG. 8.

FIG. 20 is a graph showing IDT St (Indirect Tensile Strength) and FE (Fracture Energy) compared to control mixes for (a) IDT Sₜ results and (b) IDT fracture energy results.

FIG. 21 is a graph showing IDT St and TSR (Tensile Strength Ratio) compared to control mixes.

FIG. 22 is a Table of the summary of dynamic modulus results.

FIG. 23 is a graph of flow number (Fn) comparisons.

FIG. 24 shows graphical plots of I-FIT (Illinois Flexibility Index Test) results for C₂, F₂, and HMA control mixes for (A) I-FIT flexibility index (FI) values, (B) I-FIT fracture energy values, and (C) I-FIT post-peak slope values.

FIG. 25 is a Table of summary of short- and ultimate-cure CMA properties.

FIG. 26 is a graph of CML comparison of ultimate and short-term curing.

FIG. 27 shows graphs of IDT comparison of ultimate and short-term curing for (a) IDT St results and (b) IDT fracture energy results.

FIG. 28 is a Table of field patching times and quantities.

FIG. 29 shows graphical plots of examples of patch cross sections throughout trafficking for (a) Patch 2-F₁, (b) Patch 5-HMA₁, and (c) Patch 7-C₂.

FIG. 30 is a graphical plot of illustration of total rut calculation for Patch 2 (F₁).

FIG. 31 is a Table of average field rutting results under simulated F-15E traffic.

FIG. 32 is a flow diagram illustrating an example a method of making and using a cold mix asphalt composition.

### DETAILED DESCRIPTION

Detailed illustrative embodiments of the present invention are disclosed herein. However, specific structural and functional details disclosed herein are merely representative for purposes of describing example embodiments of the present invention. The present invention may be embodied in many alternate forms and should not be construed as limited to only the embodiments set forth herein. Further, the terminology used herein is for the purpose of describing particular embodiments only and is not intended to be limiting of example embodiments of the invention.

As used herein, the singular forms “a,” “an,” and “the,” are intended to include the plural forms as well, unless the context clearly indicates otherwise. It further will be understood that the terms “comprises,” “comprising,” “includes,” and/or “including,” specify the presence of stated features, steps, or components, but do not preclude the presence or addition of one or more other features, steps, or components. It also should be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

### 1. Introduction

Embodiments of the invention are directed to an asphalt patching material composition that comprises a two-part urethane-modified asphalt binder and aggregate blend. This patching material composition has rapid repair capabilities, requiring minimal equipment and time for placement, while also providing adequate performance for a long-term asphalt repair solution.

In one embodiment, the asphalt patching material composition comprises a commercially available, urethane-modified asphalt binder and aggregate blend that can be used to complete a rapid repair, allow the roadway to be opened to traffic within about 2 hours after placement, and provide the performance needed to support extreme traffic loading. The composition may include a commercially available, urethane-modified asphalt binder, which is provided and may be mixed as a two-part system, and an aggregate blend. The aggregate blend may include, but is not limited to, materials such as, for example, gravel, crushed stone, and recycled pavement materials, or a combination thereof.

In further embodiments, a method of making a cold mix asphalt includes mixing the designed combination of the aggregate blend and two-part urethane binder in appropriate proportions (which may be predetermined or preset) to yield a quantity to be stored, either on-site or off-site, in a standard five-gallon plastic or metal bucket or other appropriate containers, for example. Prior to placement, the aggregate blend is mixed only with Part A of the two-part binder to form an initial mixture. Part A and the aggregate blend may be mixed to form a shelf stable mixture in preset proportions between Part A and the aggregate blend to yield a quantity to be stored. Part A binder may be about 1-10% by a total weight of the shelf stable mixture and the aggregate blend may be about 90-99% by the total weight of the shelf stable mixture. The term about may mean±10% (e.g., about 10% may mean 9% to 11%). Part B activator may be subsequently added to the initial mixture composition on-site using shovels or appropriate tools immediately prior to placement. After Part B is added and mixed to form the cold mix asphalt composition, the composition may be placed into the asphalt repair area and properly compacted. After about two hours, traffic can be allowed to utilize and return to and travel over the composition and repaired area.

Some of the novel and unique features and attributes of the invention are in the formulation of the mixture composition and in its performance. The two-part, urethane-modified asphalt binder provides a unique balance of the workability needed to store and manipulate the material composition until installed and placed for repair, while also yielding rapid strength gain and efficient structural capacity to support heavy aircraft and vehicle loading within about 2-4 hours (e.g., ±10%, i.e., 1.8 to 4.4 hours) after installation and/or placement.

At least three key metrics can be used to evaluate performance of asphalt patching materials: 1) rapid repair times, 2) rapid return to traffic, and 3) proven performance. Typical repair materials, such as CMA or HMA materials, cannot meet all three metrics. However, embodiments of the invention meet all three metrics and can be rapidly deployed for repair, allows traffic to return and is usable in about 2-4 hours after placement, and provides efficient performance under heavy traffic loading (e.g., F-15E aircraft loading, for example). In specific embodiments, the novel composition of the invention does not utilize typical asphalt binders which either require high temperatures for workability or rely on solvents or water mixed into the binder for workability. Both alternative scenarios present unique limitations. However, the invention is not limited to scenarios in which access to an asphalt plant or significant time required for the binder to cure and the mixture to gain strength must be considered.

The compositions and methods of the invention were originally developed to meet the extreme needs for military applications. However, it can feasibly and efficiently translate to use in multiple other commercial applications, such as for repair of potholes and other roadway distresses requiring patches that are a universal and recurring problem for asphalt pavements. As a result, the compositions of the invention may revolutionize the asphalt and pavement maintenance industry and can be used for airfield and roadway patching maintenance and repair and for repair of private pavements (e.g., privately owned parking lots and homeowner driveways, for example). Moreover, the invention with its unique capabilities can be applied to maintenance scenarios for which current compositions and products simply do not exist.

### 2. Experiments

### 2.1 Materials Tested

### 2.1.1 Aggregates

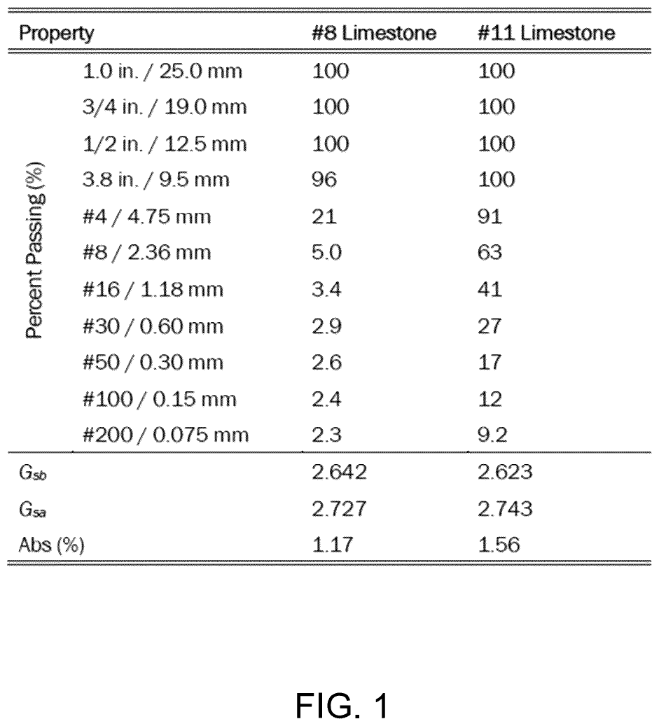

FIG. 1 is a Table of the properties of mineral aggregates. Two limestone aggregate materials were used to create CMA mixtures in this research project. ASTM C₁₁₇ (2017) and C₁₃₆ (2014) washed gradation data are provided in the Table alongside ASTM C₁₂₇ (2015a) and C₁₂₈ (2015b) bulk specific gravity (G_{sb}), apparent specific gravity (Gₛₐ), and water absorption (Abs) data. Hydrated lime is commonly used as a mineral filler and to reduce stripping potential and was used for all CMA mixes at a dose of 1% of the total aggregate blend.

Both the #8 and #11 limestones were obtained from LafargeHolcim, Vicksburg, MS. Aggregates were sampled from a stockpile into 55 gal drums, oven-dried in the laboratory, and then fractionated into several size fractions for more repeatable batching. Hydrated lime was obtained in 5 gal buckets from Falco Lime, Vicksburg, MS.

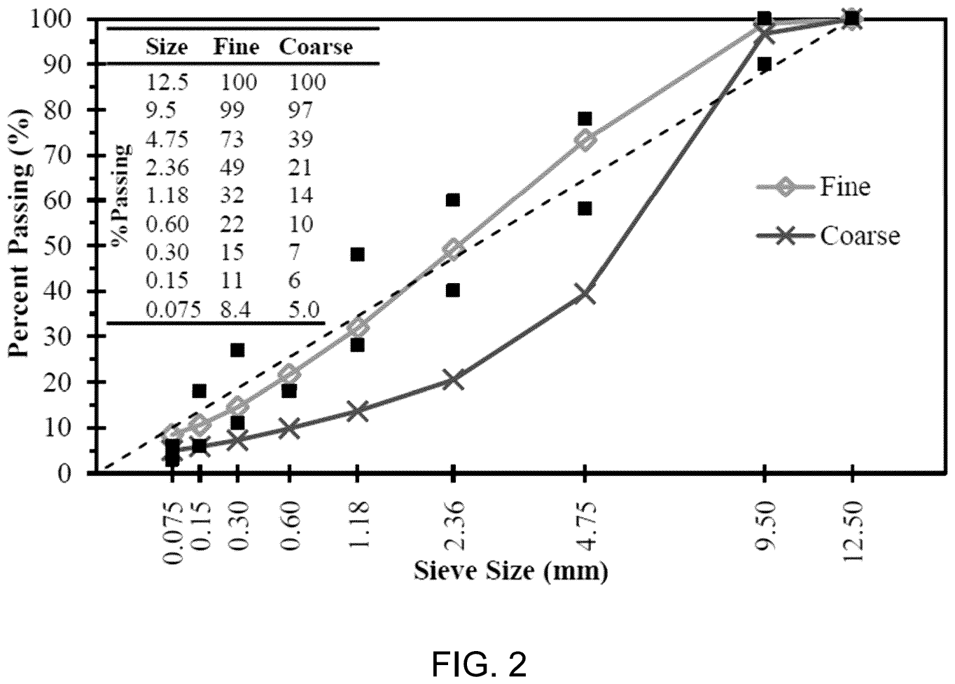

FIG. 2 shows a graphical plot illustrating the coarse and the fine gradations tested. The #8 and #11 limestones and hydrated lime were used to create two 9.5 mm NMAS aggregate blends for the CMA mixtures in this project. A coarse gradation, denoted “C,” was created using 74% #8 limestone, 25% #11 limestone, and 1% hydrated lime. A fine gradation, denoted “F,” was created using 74% #11 limestone, 25% #8 limestone, and 1% hydrated lime. FIG. 2 plots the resulting coarse and fine gradation blends.

### 2.1.2 Binders

Two bituminous binders were used to make CMA mixtures in this project. The first was a more conventional proprietary cutback asphalt (a combination of asphalt cement and petroleum solvent) referred to by the supplier as Cold Patch Binder (CPB). The second was an experimental asphalt-modified polyurethane material referred to as Blackhawk 5700 (BH5700). Note that a conventional commodity MC-250 was initially considered as well but was ultimately not included in the test plan due to its relative similarities to CPB.

CPB is a proprietary cutback asphalt supplied by Ergon Asphalt & Emulsions, Inc. It bears similar properties to an MC-250 cutback but with additional additives that are specifically marketed as beneficial for CMA mixtures. These benefits would be primarily aimed at plant-produced CMA that would be stockpiled for some period of time prior to use. CPB was selected for this project to represent what might be considered an ideal binder material among all available cutbacks.

BH5700 is an experimental binder in terms of use in asphalt mixtures. It is supplied by ErgonArmor, a division of Ergon Asphalt & Emulsions, Inc., specializing in coatings. BH5700 is a liquid-applied two-component elastomeric membrane normally intended for waterproofing applications (e.g., sealing joints or cracks). The Part B activator is typically dosed at approximately 3% (e.g., ±10%, i.e., 2.7% to 3.3%) by total weight of BH5700 (Parts A and B combined).

BH5700 was selected for its perceived promise as a CMA binder. BH5700 is typically mixed and then utilized by itself by spreading on a surface (e.g., a rooftop) with a trowel. Because it is a setting material, it was hypothesized that BH5700 may make an excellent CMA binder from a stability standpoint relative to cutbacks, which cure quite slowly as solvents evaporate. It had not been previously tested for use in this manner; this research project represents the first case of which the researchers are aware in which BH5700 was used as an asphalt mixture binder.

### 2.1.3 COTS SMA Control Mixtures

Two commercial-off-the-shelf (COTS) CMA mixtures were selected as CMA control mixtures. These were Instant Road Repair (IRR), supplied by International Roadway Research, and Aquaphalt 6.0 (AQ), supplied by Roadstone Production, LLC. Both products classify as proprietary CMA materials and were obtained in 3.5 gal buckets.

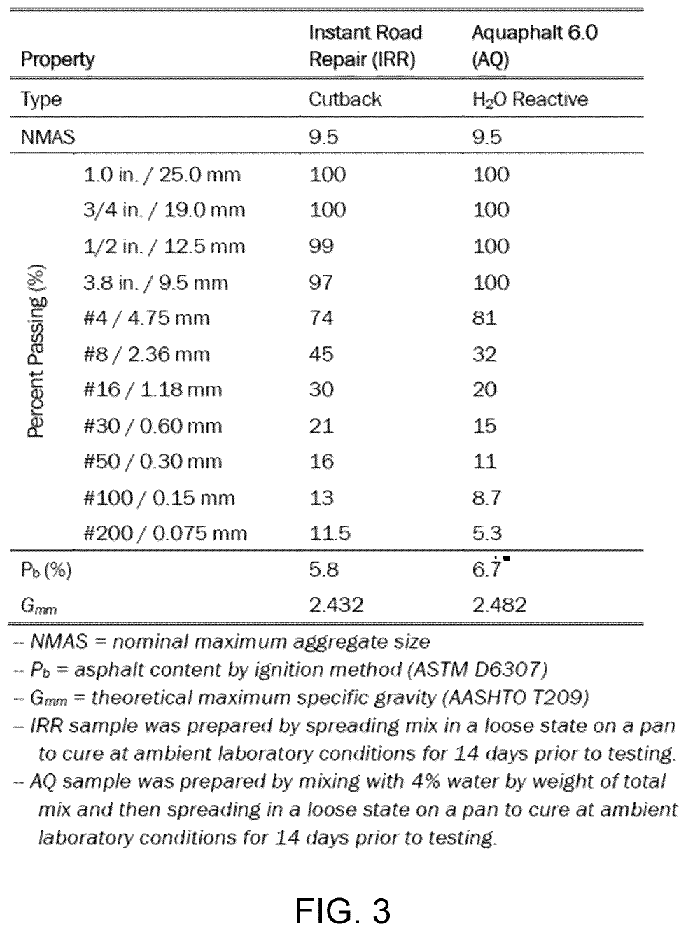

FIG. 3 is a Table of the properties of COTS CMA control mixtures. IRR is a fairly conventional CMA using a cutback asphalt binder, whereas AQ utilizes a proprietary water-reactive binder formulation. Manufacturer instructions state to pour about 0.5 gal of water over each 3.5-gal bucket of AQ prior to compaction. Exact curing mechanisms of the water-reactive formulations are not known; however, they are known to typically contain plant-based oils and a reaction-assisting component that, when mixed with water, chemically react and promote strength development. Key properties of each CMA are shown in the Table in FIG. 3.

IRR was utilized as a control mix because it is the currently specified product used in the Air Force Sustainment Pavement Repair (SuPR) Kit, and it has been consistently included in the U.S. Army Engineer Research and Development Center (ERDC) patching evaluations, as shown in the Table in FIG. 1. Note that International Roadway Research appears to have recently gone out of business, and IRR is no longer commercially available. IRR data in this report were collected using materials already on hand at ERDC. Though no longer available, testing IRR was deemed worthwhile, given its history in ERDC evaluations, its use in the SuPR Kit, and the need to obtain previously unmeasured properties for reference to CMAs developed in this project.

AQ was utilized as a second control mix because the water-reactive class of CMAs was identified as the best performing in a 2017 study. As a result, the Air Force has recommended it for cold patching repairs on several occasions, although it is not formally on any sort of qualified products list (QPL) at present. It should also be noted that Instant Asphalt was tested in a 2020 study. However, all three water-reactive CMAs tested in the 2017 study (i.e., Aquaphalt 6.0, AQUA PATCH, and Instant Asphalt 6.0, as shown in the Table in FIG. 1) were similar in nature. It is possible that multiple manufacturers licensed rights to a single patent. For purposes of this report, AQ and Instant Asphalt 6.0 are considered similar.

### 2.1.4 HMA Control Mixtures

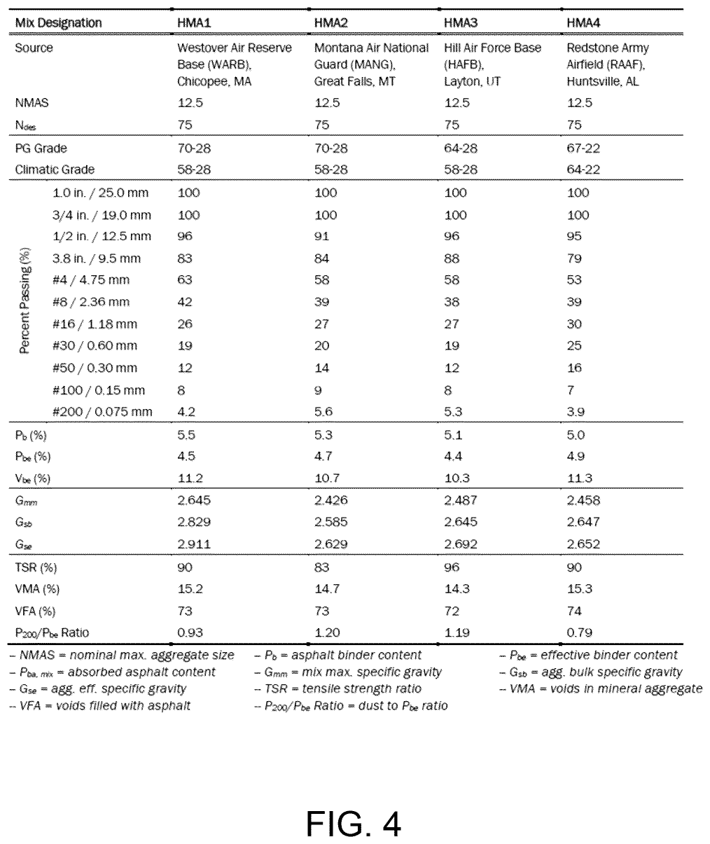

FIG. 4 is a Table of the mix design properties of HMA control mixtures. Four HMA airfield mixtures, designated HMA₁ to HMA₄, were used as control mixtures to benchmark CMA performance against typical HMA performance. All were 75 gyration plant-produced mixes that were sampled in 5 gal buckets at the plant or construction site and later reheated for specimen preparation.

### 2.2 Experimental Program

Cold mixes designed and tested in this report are referred to by the aggregate gradation and binder type. Both coarse and fine gradations were evaluated and were denoted “C” and “F,” respectively. CPB binder was denoted binder 1, and BH5700 was denoted binder 2. Thus, a mix labeled C₁ refers to the coarse gradation with CPB; F₂ refers to the fine gradation with BH5700, and so forth.

### 2.2.1 Laboratory Specimen Preparation

### 2.2.1.1 Mixing and Compaction

Laboratory-produced specimens all followed the same process described in this section. Aggregates were first batched from individual size fractions at the correct proportions. All mixing and compaction took place at ambient temperature.

Aggregate batches were placed in the mixing bucket on a scale, and the correct binder weight was added as a percent of total mixture. Binder contents were calculated based on the estimated amount of residual binder after solvent evaporation; these residual percentages were approximated via several experiments to be 75% for CPB and 90% for BH5700. For example, 4.5% CPB implies that the residual binder content is 4.5% after complete curing, whereas the total cutback binder including solvent added during mixing would be 6.0%.

Mixing took place in the bucket mixer. Mixing continued until aggregates were fully coated in binder, which was generally 2-3 minutes for CPB or 3-4 minutes for BH5700 Part A, which was more viscous than CPB. For BH5700, the bucket was placed back on the scale after initial mixing to weigh in the correct dose of Part B, after which the material was mixed again for approximately 3-4 minutes to ensure thorough distribution of Part B. For this project, all laboratory specimens were mixed with 3.0% Part B (dosed by total weight of BH5700), and field mixes utilized 4.0% Part B.

Immediately after mixing, material was batched into room-temperature gyratory molds and compacted in the Pine AFGC 125X Superpave gyratory compactor (SGC) for a design gyration (Ndes) level of 30 gyrations. This represents a fairly low Ndes level compared to HMA specifications but was selected since field compaction effort for CMA patch repairs is generally less than that of normal asphalt construction. For either 100 or 150 mm-diam specimens, batch weights were adjusted to obtain the desired specimen heights when compacted to 30 gyrations.

### 2.2.1.2 Curing

Specimens were immediately extruded from the mold following compaction and carefully moved to their respective curing location. Based on preliminary testing, C₁ and F₁ specimens with the CPB binder were not stable enough to remain intact while curing and would slump and deform. To mitigate this issue, plastic sleeves that were just shorter than the specimens were cut from concrete cylinder molds; each sleeve was also cut with a vertical slit to allow the sleeve to fit each specimen's exact diameter. Sleeves were then wrapped around each specimen and secured with rubber bands to provide a minimal amount of confinement to keep the specimen intact throughout curing. Specimens were supported by perforated aluminum plates that also allowed airflow across the bottom of the specimens.

Curing took place in either a 60° C. oven for as long as 45 days or on a lab countertop at ambient conditions for as few as 3 hr. Generally speaking, C₁ and F₁ (CPB) specimens were cured at 60° C., and C₂ and F₂ (BH5700) specimens were cured at room temperature. Following curing, C₁ and F₁ specimens were brought to room temperature, and sleeves were removed.

Binder drain down occurred for C₁ at higher binder contents (to some degree at 4.5% but particularly at 5.0%). This made it difficult to remove specimens from the perforated plates after curing, and the bottoms of 2 specimens at 4.5% binder and 14 specimens at 5.0% binder were damaged. Since most of the specimens were intact, the decision was made to place the specimens in a freezer to cool for a brief period and then remove the damaged portions by saw trimming.

The thickness removed from trimmed specimens averaged approximately 14 mm and ranged from 9 to 19 mm. For some tests, such as IDT (Indirect Tensile (Strength)) tests, trimming had little impact, since specimen thickness is measured and accounted for in test result calculations. For wheel tracking tests, test standards allow specimens to be shimmed to the correct thickness using plaster or grout. Trimming could potentially affect Cantabro testing, since thickness is not used in calculations but may affect the result, depending on the deviation in thickness from the test requirement. However, any effects of trimming on Cantabro results were overshadowed by other factors, as shown in Section 3.1.5. Overall, the trimming and, if applicable, shimming approach was believed to be a reasonable means of addressing the damaged specimens.

### 2.2.1.3 Density Measurement

Mixture bulk specific gravity (Gmb) was measured on each specimen after curing according to AASHTO T331 (2013) using the CoreLok vacuum sealing device. Gmb was measured with the understanding that any residual solvent remaining in a specimen would affect Gmb values; however, for specimens that were evaluated at their ultimate-cure conditions, this was assumed to be a negligible issue.

Maximum theoretical specific gravity (Gₘₘ) was measured via AASHTO T₂₀₉ (2020b) on loose mixes that were prepared following similar batching and mixing protocols, as in Section 2.2.1.1, and then spread on pans and placed in a 60° C. oven to cure. Air voids (Vₐ) were calculated as normal, using G_{mb} and Gₘₘ.

### 2.2.1.4 CMA Control Mixture Specimen Preparation

CMA control mixes IRR and AQ were prepared similarly to lab-produced CMA specimens with several exceptions. IRR was simply batched directly into gyratory molds and compacted 30 gyrations. AQ was batched from the bucket into a metal pan, where 4% water by weight of AQ mixture was poured over the mix to evenly wet it. Excess water was then strained off, and the wetted mix was transferred to room-temperature gyratory molds. Compacted specimens were then cured and measured for density.

As before, G_{mb} measurements were not adjusted to account for any residual solvent or water remaining in the specimens. Also, Gₘₘ samples were mixed identically to mixes prepared for compacted specimens but then cured loose on a pan at ambient conditions for 14 days.

### 2.2.1.5 HMA Control Mixture Specimen Preparation

HMA control mixes were prepared by first reheating 5 gal buckets of plant mix to a low temperature between 93° C. and 121° C. Once workable, each bucket of mix was split into pans containing the approximate weight required for a specimen of desired dimensions (e.g., 115 by 150 mm or 63 by 100 mm). By splitting an entire bucket at a time, segregation was minimized; prebatching pans with the proper batch weights also increased productivity, since the pans reheated faster than a full bucket.

For specimen compaction, prebatched pans were heated to 149° C. to 160° C., and then mix was transferred to hot gyratory molds and compacted in the gyratory compactor. Specimens were compacted to target heights rather than to a specific gyration level. Batch weights were adjusted to achieve specific Vₐ levels at the set target heights, based on initial Vₐ versus batch weight regression analyses.

In general, 8.0%±0.5% Vₐ was targeted for most HMA specimens, as measured by the AASHTO T331 (2013) CoreLok method. This approximately corresponds with 7.0%±0.5% Vₐ if measured by the more traditional AASHTO T₁₆₆ (2016) method. The ERDC asphalt research group predominantly used the CoreLok method due to its greater accuracy and efficiency and then applied an offset so that specimens were prepared with equivalent Vₐ levels compared to other labs that used T₁₆₆. At 7.0% Vₐ, the T331 equivalent was approximately 8.0%; at 4.0% Vₐ, the T331 equivalent was approximately 4.5%.

### 2.3 Laboratory Testing

Various tests were performed, ranging from simple mechanical tests to more complex mechanical tests. Some were more historical tests, such as Marshall stability, and some were more modern tests, such as the Cantabro durability test. In general, the testing regime focused on rutting and stability properties, intermediate temperature durability and cracking properties, and moisture susceptibility.

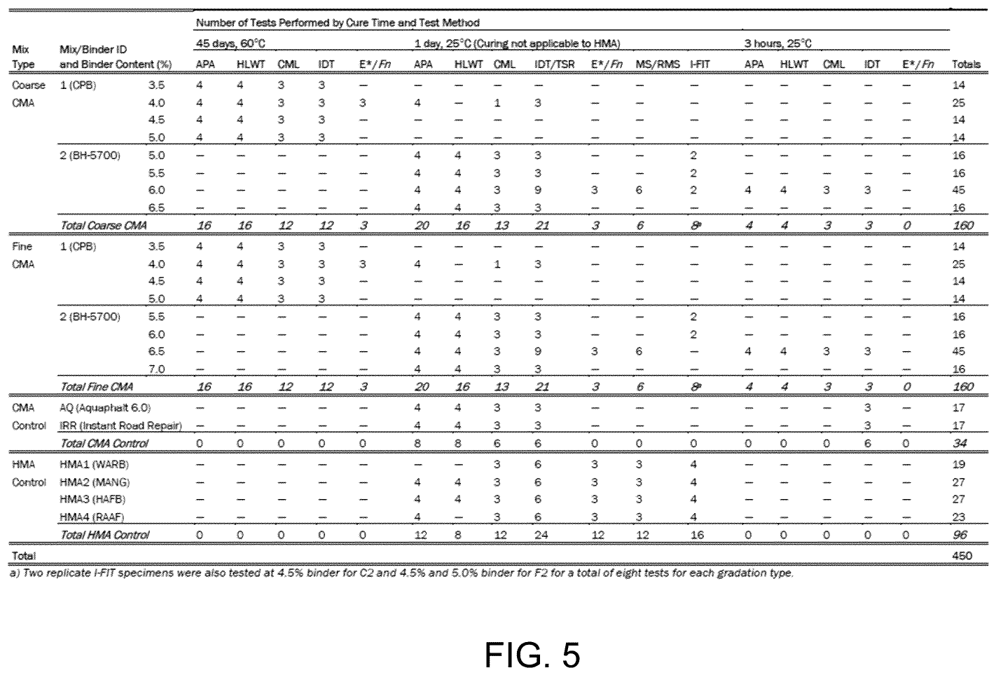

FIG. 5 is a Table summarizing the laboratory experimental plan utilized in this project. In all, 450 laboratory specimens were made and tested, not including specimens that were made and tested as part of preliminary work.

Breaking the Table down into specific efforts, Task 1 focused on performing the mix design process for four ERDC-designed CMA mixtures (C₁, F₁, C₂, and F₂). A hybrid design approach was utilized that assessed both volumetrics like normal asphalt mix design as well as multiple mechanical tests. These included APA (Asphalt Pavement Analyzer), HLWT (Hamburg Loaded Wheel Tracking), CML (Cantabro Mass Loss), and IDT St (Indirect Tensile Strength) tests where each test was performed at four binder contents per mixture. In all, 56 specimens per mixture, or 224 total specimens, were produced and evaluated as part of the Task 1 mix design effort.

All Task 1 specimens were cured to what was considered ultimate-cure conditions. For C₁ and F₁ (CPB) specimens, 45 days of curing at 60° C. was used; for C₂ and F₂ (BH5700) specimens, 1 day of curing at 25° C. was used.

Task 2 performed further testing of each mix at the selected design binder content for that mix at the ultimate cure condition. This included dynamic modulus and flow number testing for all mixes. For C₂ and F₂ (BH5700) mixes, TSR (Tensile Strength Ratio), MS (Marshall Stability), RMS (Retained Marshall Stability), and I-FIT (Illinois Flexibility Index Test) tests were also performed. In all, 52 tests were performed as part of Task 2.

Task 3 assessed early-cure properties for each cold mix. For C₁ and F₁ (CPB), early curing was taken to be 1 day at 25° C. (i.e., same as ultimate curing for BH5700), and for C₂ and F₂ (BH5700), early curing was taken to be 3 hr at 25° C. In general, all tests performed in Task 1 were performed again in Task 3 except that only the design binder content was tested for each mix. Note that for C₁ and F₁, specimens were not sufficiently stable to withstand much handling at 1 day. Therefore, HLWT testing was not performed, since specimen preparation required sawing, and only one replicate CML test was performed. In all, 44 tests were performed as part of Task 3.

Task 4 benchmarked mixes evaluated in Tasks 1 to 3 against COTS CMA products AQ and IRR. All Task 1 tests were performed in Task 4, and most curing was for 1 day at 25° C. for comparison primarily to C₂ and F₂. Several IDT tests were also performed at the early-cure time of 3 hr at 25° C. In all, 34 tests were performed in Task 4.

Lastly, Task 5 collected benchmark data for four airfield HMA control mixes. Curing time was not applicable to HMA mixes; they were stored at ambient conditions in the lab after compaction and until testing. Note that APA data were not available for HMA₁, and HLWT data were not available for HMA₁ or HMA₄. In all, 96 tests were performed in Task 5.

### 2.4 Full-Scale Field Testing

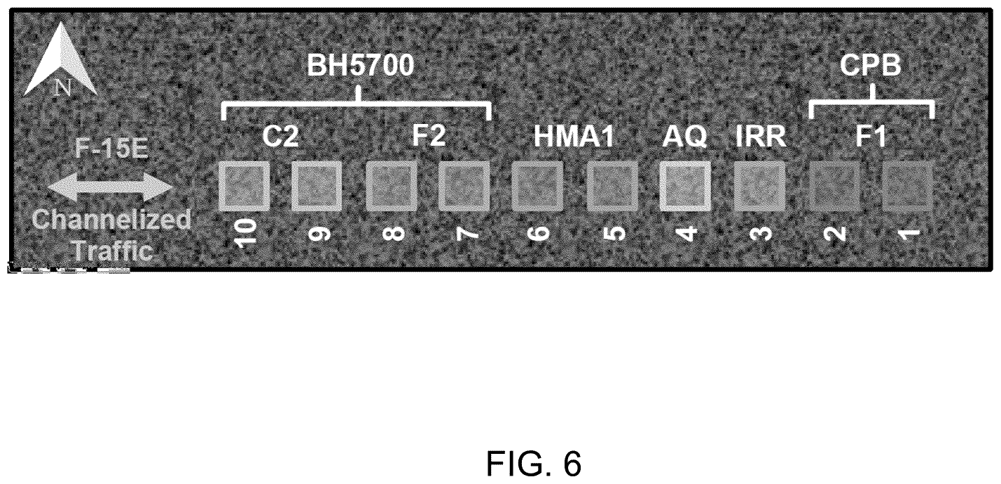

Following all laboratory testing, a full-scale field test was conducted at ERDC's Outdoor Pavements Test Facility to investigate field performance of CMA and HMA materials under simulated F-15E aircraft loading. FIG. 6 portrays a diagram of the field testing layout at the U.S. Army Engineer Research and Development Center (ERDC) outdoor pavements test facility. Ten 2×2 ft patches that were 4 in. deep were repaired using six materials studied in the laboratory. The only material not tested in the field was CPB mix C₁; it was omitted due to similar lab performance as F₁, so F₁ was selected to represent CPB. Additionally, patches were ordered in the order in which failure was anticipated based on lab test results; this was done so that if some patches failed (e.g., Patches 1 to 3), trafficking could continue on remaining patches with no risk of damage to the F-15E load cart. The following subsections detail the process of performing patching repairs and collecting data throughout trafficking.

### 2.4.1 Test Section Pavement

Field testing at the Outdoor Pavements Test Facility took place within a 50×180 ft airfield asphalt test section that was built in March 2021. Asphalt thickness was nominally 8 in., paved in four 2 in.-thick lifts over 12 in. of crushed limestone base. The section was paved with a Gradation 3 mix design (9.5 mm NMAS) meeting general design requirements of UFGS (United Facilities Guide Specification) 32 12 15.13 (2020) for airfield paving. The mix utilized a neat PG (Performance Grade) 67-22 binder with a design asphalt content of 5.7%. In-place Vₐ averaged 7.0%, as measured by AASHTO T331 (2013), which would be roughly equivalent to 6.0% by AASHTO T₁₆₆ (2016). Patches were located in one paving lane in the approximate center of the lane to avoid longitudinal joints.

### 2.4.2 Patch Preparation

Simulated patches were cut out of the pavement using a walk-behind diamond blade saw. Cuts were made approximately 4.5 in. deep in order to remove the top two lifts of pavement for a 4 in.-deep repair. Four perimeter cuts were made, followed by several relief cuts in the middle of the patch that allowed the patch to be broken out in several large pieces using pry bars. In general, all patches were able to be broken out cleanly at the lift interface between the second and third lifts. Once debris was removed and dust was blown away, the pavement was sprayed down with water and allowed to dry, so the pavement was clean prior to performing repairs.

### 2.4.3 Patching Process

The patching process was performed in numerical order from Patch 1 to Patch 10. Patching mix was placed directly in each repair (i.e., no tack coat was applied) and compacted in two approximately equal 2 in. lifts. Handling procedures were slightly different for each mix.

For F₁, mix was prepared in the lab ahead of field patching by batching and mixing aggregates and CPB binder and then transferred to plastic 5 gal buckets and sealed until use. For field testing, F₁ buckets were simply opened, poured into a patch, leveled, and then compacted. Handling was similar for IRR and AQ except that lab mixing was not required, since it was a commercial product. The only other difference with AQ is that approximately 0.5 gal of water per 3.5-gal bucket was poured evenly over the patch after mix was leveled but before it was compacted.

For HMA₁, mix was heated in the original 5-gal metal buckets in which it was sampled. Mix was heated in the lab to 160° C. and brought to the Outdoor Test Section immediately prior to use. On site, it was poured into patches, leveled, and then compacted.

For F₂ and C₂, mix was prepared in the lab ahead of field work by batching and mixing aggregate with BH5700 Part A. It was then transferred to plastic 5 gal buckets (approximately 75 lb each) and sealed until use. For field testing, mix was poured from the bucket onto a flat surface and spread into a thin layer that was fairly uniform in thickness. BH5700 Part B was then weighed out on a portable scale to achieve 4% Part B by total weight of BH5700. Part B was poured evenly over the mix and then thoroughly mixed approximately 3 minutes by two technicians with shovels. For this test, a sheet of plywood was used as the flat surface on which mixing took place because it was convenient for ease of mixing and transfer of material into patches after mixing. Mix was leveled in the patch and then compacted.

Compaction was performed using two vibratory plate compactors. A smaller Northern Industrial JPC-80 with a 16.5 in.-wide plate was used to compact the first lift, and a slightly larger Wacker Neuson VPG160B with a 21 in.-wide plate was used to compact the second lift. During compaction, care was taken to confine the mix in the repair for clean but dense repair edges. Multiple passes were made until it was evident the compactor had densified the patch to the point that further compaction had minimal effect.

### 2.4.4 Trafficking

Trafficking was performed with the F-15E load cart at the fully loaded F-15E parameters of 325 psi tire pressure and 35,235 lb wheel load. For this test, channelized trafficking was applied to the patches beginning 3 hr after completion of the last patch (Patch 10). The goal was to reach 100 passes with 1 in. (25 mm) or less of rutting. The first 100 passes were applied immediately after the cure time; however, trafficking of some patches continued on the following day out to 500 passes. The next section describes the data collection process.

### 2.4.5 Data Collection

Surface profiles were measured using a reference straightedge on each patch prior to performing repairs, after repair but prior to trafficking, and throughout trafficking. Pass intervals at which trafficking was stopped for data collection were 0, 2, 6, 12, 24, 50, 74, 100, 150, 200, 300, 400, and 500 passes.

Surface profiles were measured using a 4 ft straightedge (1×2 in. aluminum tubing) that was supported at either end by 1 in.-tall supports to raise the straightedge above the pavement surface and provide clearance for any upheaval that may have resulted from trafficking. Digital calipers were tared around the full 3 in. thickness of the straightedge and end supports so that the original pavement surface was used as the baseline (i.e., caliper reading of 0.0 mm at the original pavement surface). Following this approach, ruts were measured as positive displacement, and upheaval was measured as negative displacement.

Seven cross-section surface measurements were recorded in 6 in. intervals starting at the centerline (0 in.) and then ±6 in., ±12 in. (edge of patch), and ±18 in. (6 in. outside each patch on the original pavement). Because measurements at these fixed locations did not always capture the rut and upheaval extremes, three additional measurements were obtained with each survey: the maximum rut depth and the highest upheaval on either side of the rut. Note that centerline profile measurements were originally measured at 0 passes; however, the parent pavement rutted to the point that centerline measurements were not informative and were not carried out throughout the rest of trafficking.

### 3. Laboratory Results

### 3.1 Balanced Mix Design of Lab-Designed CMA

Mix design specimens were prepared for each mix (C₁, F₁, C₂, F₂) at four different binder contents in 0.5% increments. Fifty-six specimens per mix were compacted to 30 gyrations in various sizes, depending on the test for which they were compacted. The 115×150 mm specimens compacted for Cantabro testing were also utilized for traditional volumetric mix design assessments.

### 3.1.1 CPB Curing Profiles

Recall that all specimens were subjected to the ultimate-property curing regime that corresponded to the binder type. CPB specimens were cured 45 days in a 60° C. oven, whereas BH5700 specimens were cured only 1 day at 25° C. Throughout the 45 days of oven curing, CPB specimens were periodically weighed to track mass loss and determine the degree of curing.

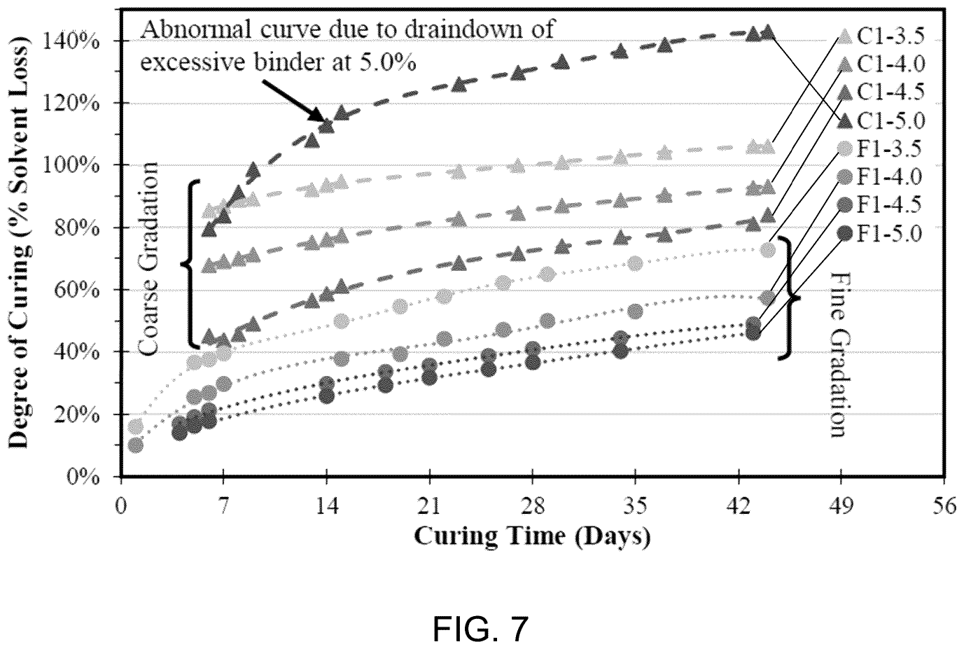

FIG. 7 is a graphical plot illustrating curing profiles for CPB C₁ and F₁ mixes. The figure shows mass loss curves for each C₁ and F₁ binder content. Notice that the C₁ curve at 5.0% binder exceeds 100% solvent loss, which is not logical; this was attributed to binder drain down that occurred for the coarse gradation at the highest binder content (i.e., mass loss changes were due to both binder drain down and solvent loss but could not be distinguished). This did not happen for F₂ at 5.0% due to the denser gradation and thinner film thicknesses.

At the time CPB C₁ and F₁ specimens were placed in the oven for ultimate curing, the length of curing had not yet been established. At the beginning of the research project, a 3-day cure time was proposed; however, preliminary investigations made it clear that 3 days would not be sufficient. Instead, this approach was taken to monitor the degree of curing based on the percent solvent loss and to determine the ultimate cure time.

Based on mass loss, FIG. 7 shows that mixes with lower binder contents tended to cure faster, which is logical since there would be less total solvent to evaporate and higher air voids which would better facilitate solvent loss. Following similar logic, C₁ mixes with the coarse gradation cured faster than F₁ mixes with the denser fine gradation. After 30 days, it became apparent that even with very generous, and arguably excessive, cure times, many mixes would not reach full cure, as defined by 100% solvent loss. Instead, the decision was made to terminate curing at 45 days and deem this the ultimate-cure condition for CPB mixes.

At 45 days, C₁ mixes ranged from approximately 80% to 100% cured (note that C₁-3.5 actually exceeds 100% slightly, but percent solvent loss calculations are approximate). F₁ mixes ranged from about 45% to 75% cured as measured by solvent loss. However, once specimens were removed from the ovens and cooled and the sleeves were removed, all specimens were stable.

### 3.1.2 Summary of Properties Measured

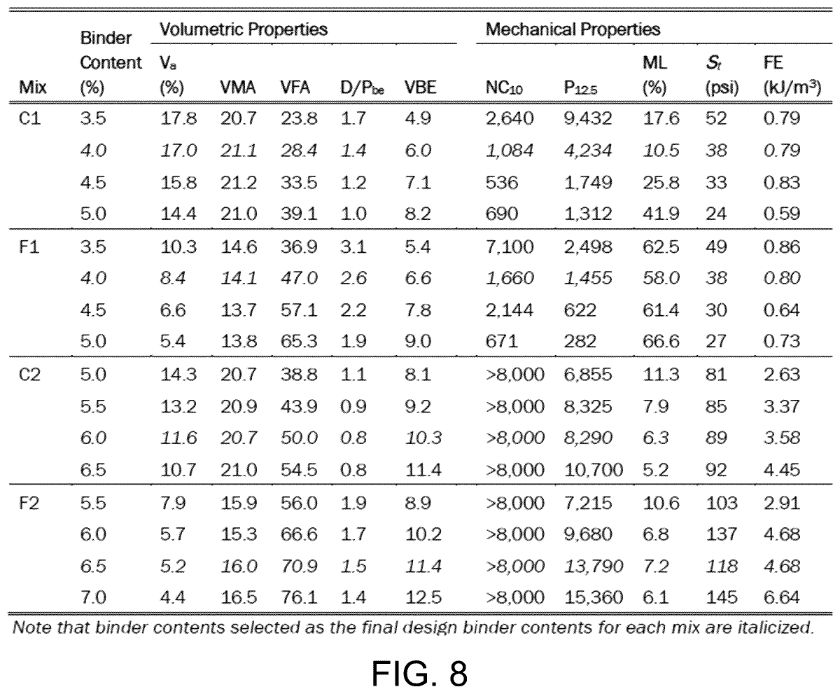

FIG. 8 is a Table showing a summary of balanced mix design properties for lab-designed CMA. The Table summarizes volumetric and mechanical properties for all four mixes and forms the basis for all discussion in this section. An immediate observation from the Table is that typical HMA volumetric principles are not applicable for this effort. The literature has also noted the difficulty in using normal volumetric design criteria for CMA. For example, 4.0% air voids, which is the typical design value for HMA, was not achieved with any binder content for any mix. It would be neither practical nor reasonable to increase binder contents beyond the ranges presented in the Table to attempt to reach 4.0% Vₐ. For this reason, the approach taken in this disclosure was to evaluate both volumetric and mechanical properties, relying primarily on mechanical properties, to determine design binder contents.

### 3.1.3 APA Rutting Properties

BH5700 C₂ and F₂ mixes exhibited much more favorable APA rutting behaviors than CPB mixes and were largely indifferent to binder content. All BH5700 binder contents performed well in terms of APA rutting. Conversely, CPB C₁ and F₁ mixes performed poorly and were more sensitive to binder content.

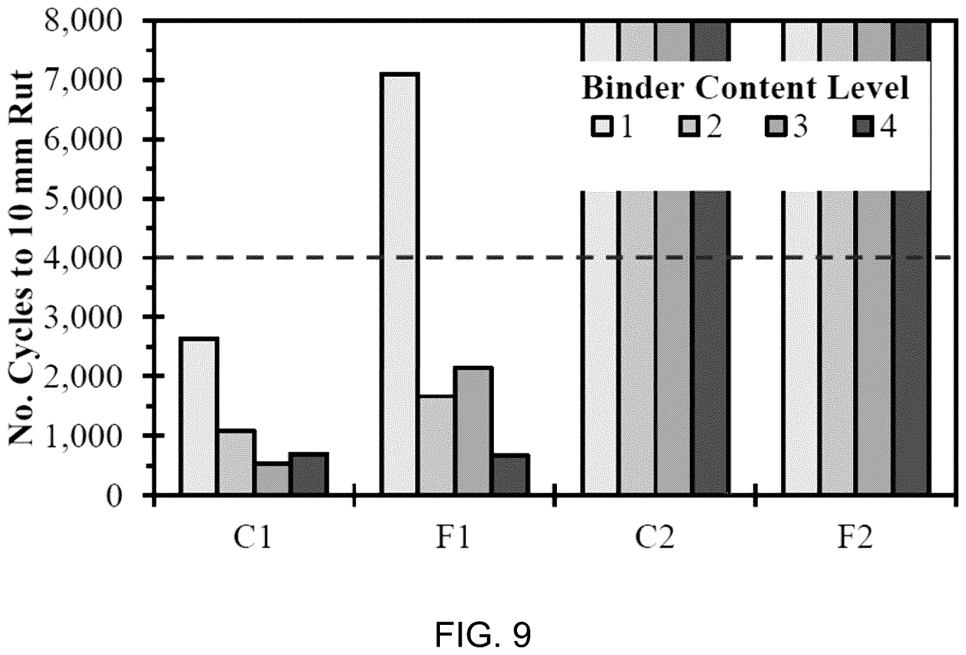

FIG. 9 is a graphical plot of the number of APA (Asphalt Pavement Analyzer) cycles to 10 mm rut for CMA balanced mix design. It graphically depicts NC₁₀ data from the Table of FIG. 8 and illustrates the FAA's NC₁₀ pass/fail threshold of 4,000 as a dashed red line. All BH5700 mixes easily exceed this threshold, whereas CPB mixes fall well short of the threshold with the exception of F₁ at 3.5% binder. Interestingly, F₁ fared disproportionately better at 3.5% binder than at other binder contents. CPB specimens are fully rutted to the limits of the APA test, whereas BH5700 specimens show minor abrasion wear from the APA hose but no visible rutting.

### 3.1.4 Hamburg Rutting and Moisture Damage Properties

In general, Hamburg performance for CPB C₁ and F₁ mixes is not all that different from the APA performance. Although somewhat unexpected when compared to the exceptional APA performance, BH5700 mixes were not as distinguishable from CPB mixes based on Hamburg testing, and all exhibited defined stripping inflection points.

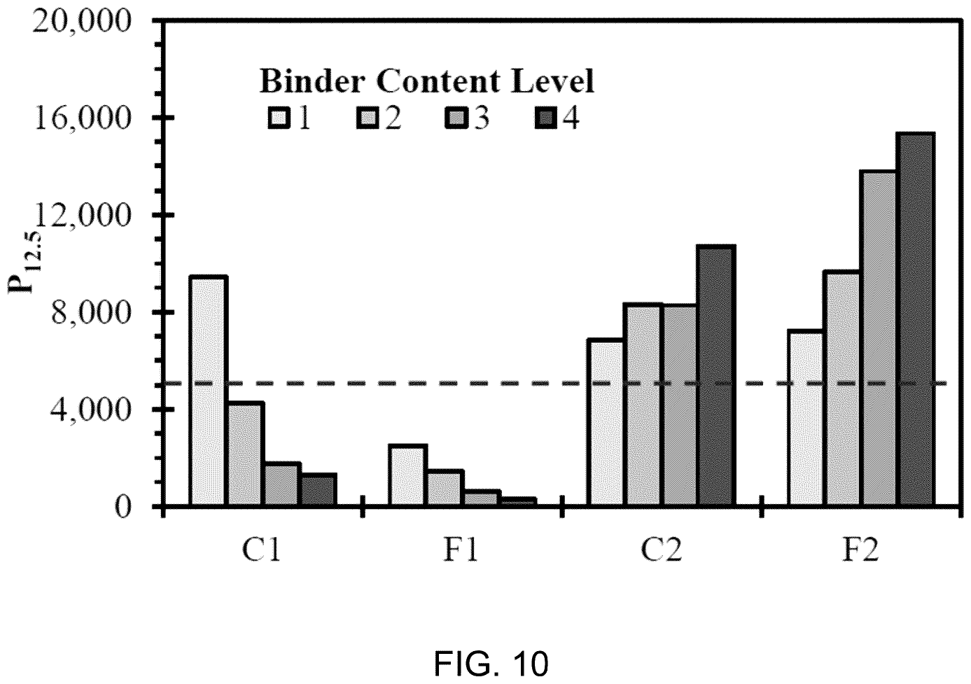

FIG. 10 is a graphical plot of the number of Hamburg passes to 12.5 mm rut for CMA balanced mix design. It displays Hamburg P_{12.5} results alongside a 5,000-pass threshold, which is often used as a pass/fail threshold for Hamburg testing. In this case, it is used more for conversational purposes to provide context than for normal pass/fail purposes; however, it is helpful in showing the differences between CPB and BH5700 mixes. Unlike APA testing, all mixes were sensitive to binder content based on Hamburg testing. Hamburg results worsened with increased CPB binder but improved with increased BH5700 binder.

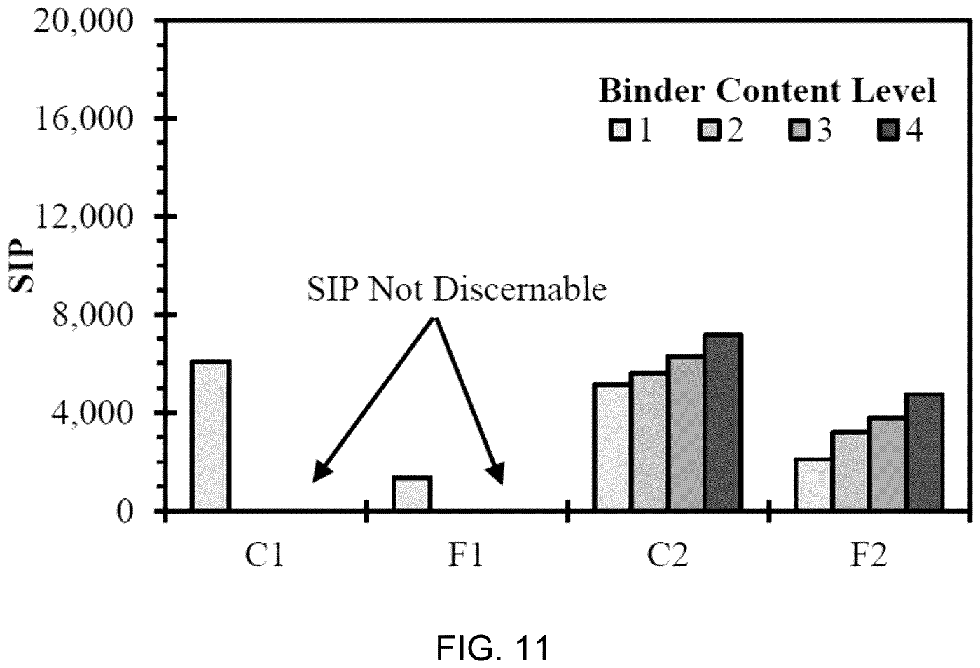

FIG. 11 is a graphical plot of Hamburg stripping inflection points for CMA balanced mix design. It presents Hamburg SIP (Stripping Inflection Point) data not shown in the Table of FIG. 8. SIPs could not be determined for C₁ and F₁ at 4.0% to 5.0% binder simply because they rutted too quickly. For BH5700, SIP increased with each increasing binder increment. Considering FIGS. 10 and 11 collectively, CPB mixes are soft rut-prone mixes for which increasing binder content decreases performance; BH5700 mixes are more susceptible to moisture damage than rutting and are improved by increasing binder content. The excessive upheaval and deformation of the CPB mixes are evident in the tested Hamburg specimens.

Likewise, the moisture damage effects on BH5700 mixes are visible in the form of stripped, uncoated aggregates in the wheel path.

### 3.1.5 Cantabro Durability Properties

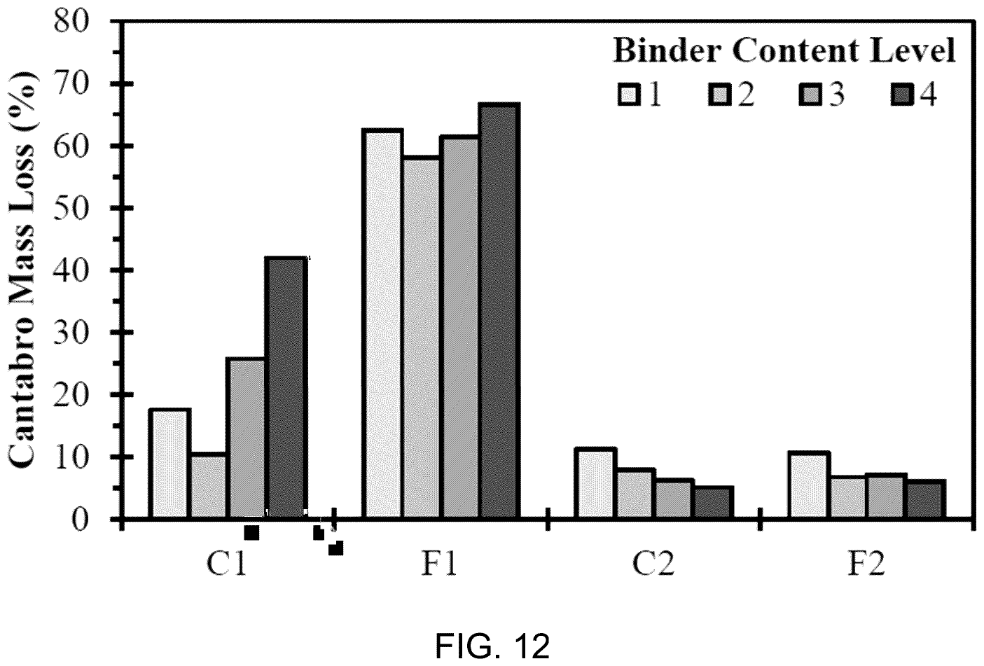

FIG. 12 is a graph of CML (Cantabro Mass Loss) for CMA balanced mix design. It presents the Cantabro results in the Table of FIG. 8 graphically. For both CPB mixes, there appears to be an optimum binder content where mass loss is lowest at Pb, 2, or 4.0%. Aside from C₁ at 4.0%, most CPB mass losses are excessive. Mass loss for BH5700 mixes is low and exhibits a decreasing trend with increasing binder content.

### 3.1.6 IDT Strength Properties

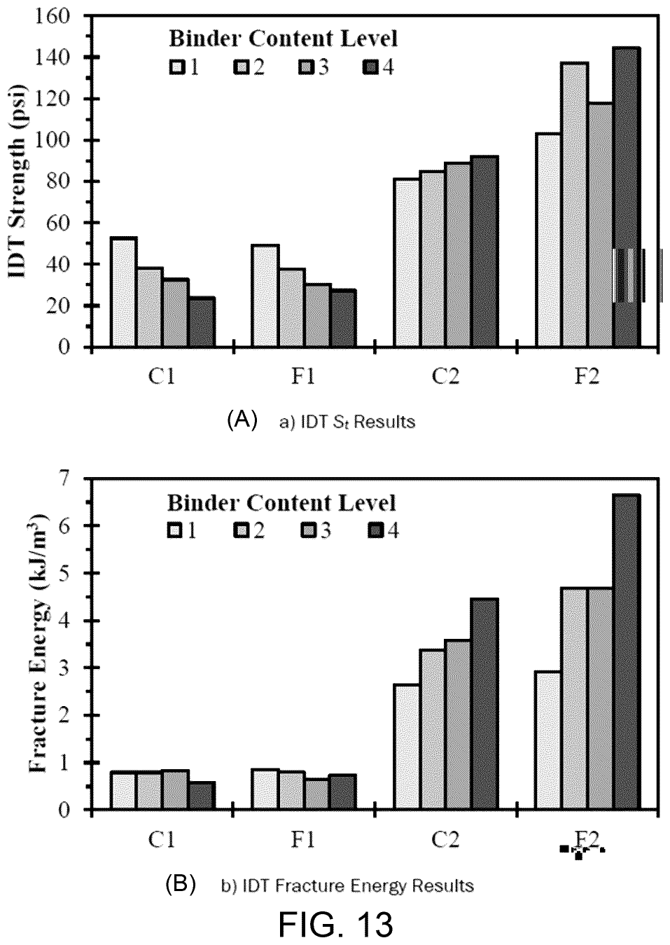

FIG. 13 is a graphical diagram illustrating IDT (Indirect Tensile) results for CMA balanced mix design for (A) IDT St results and (B) IDT fracture energy results. It presents IDT St and FE (Fracture Energy) results in the Table of FIG. 8 graphically. While FE is relatively unaffected by binder content for CPB mixes, St decreases considerably with increasing binder content, ranging from around 50 to 20 psi. Both St and FE are sensitive to binder content for BH5700 mixes and increase as binder content increases.

### 3.1.7 Design Binder Content Selection

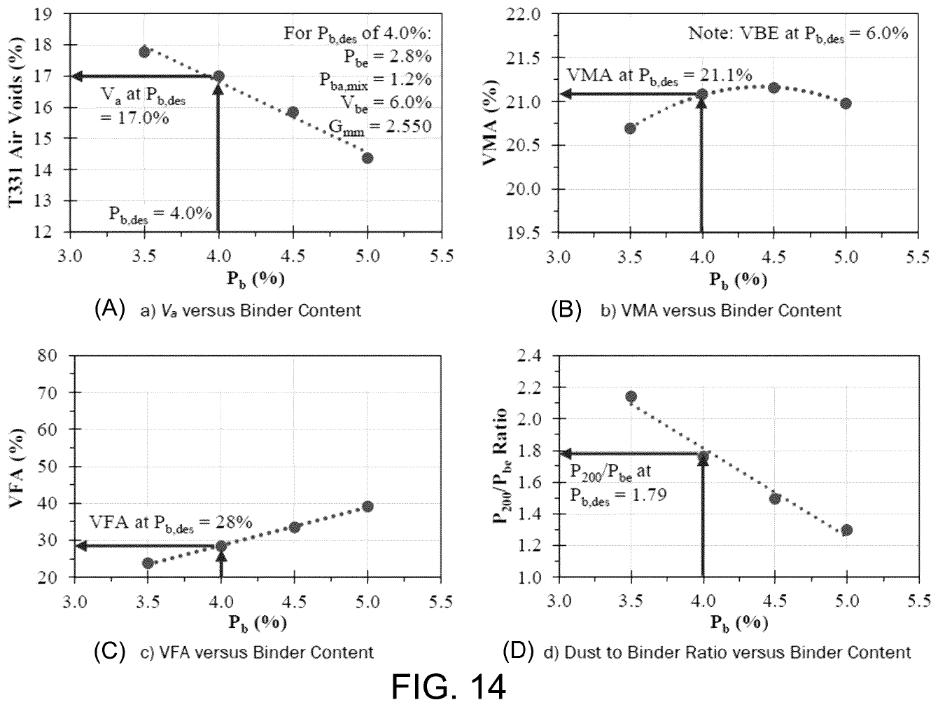

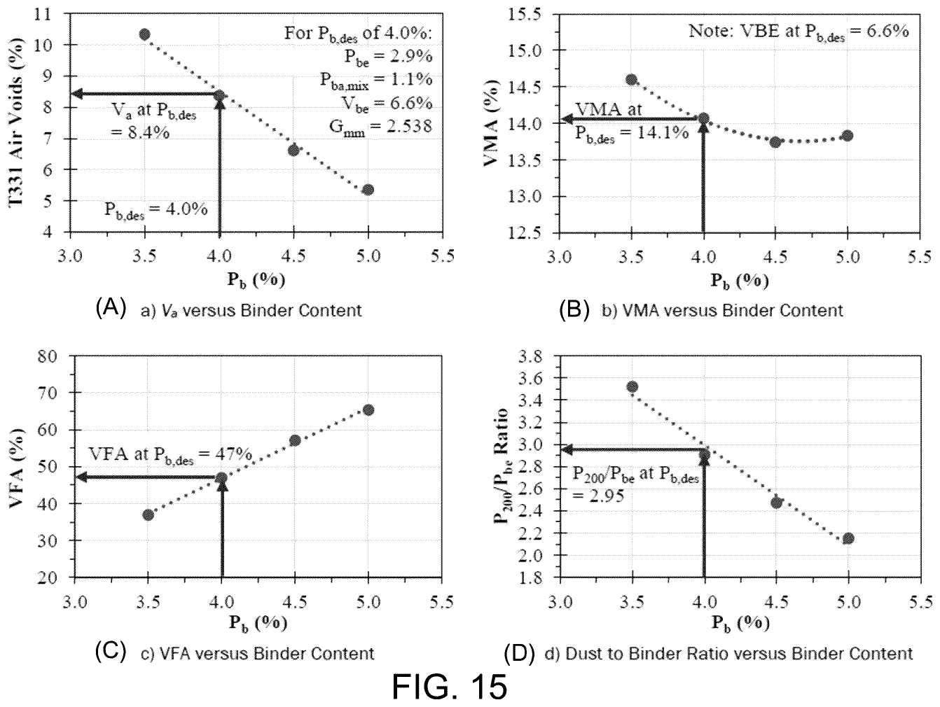

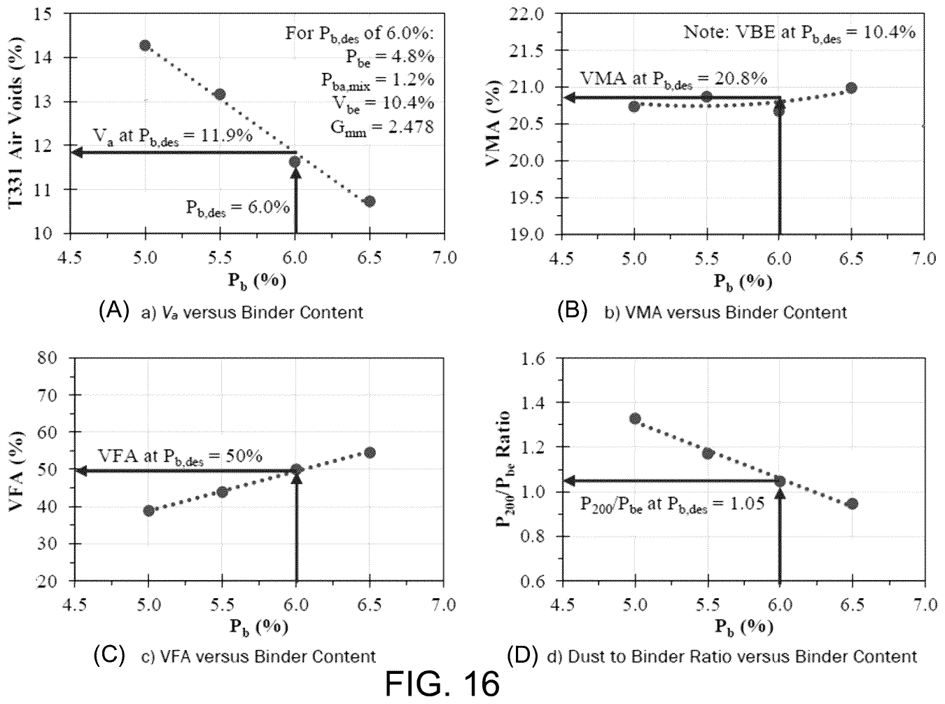

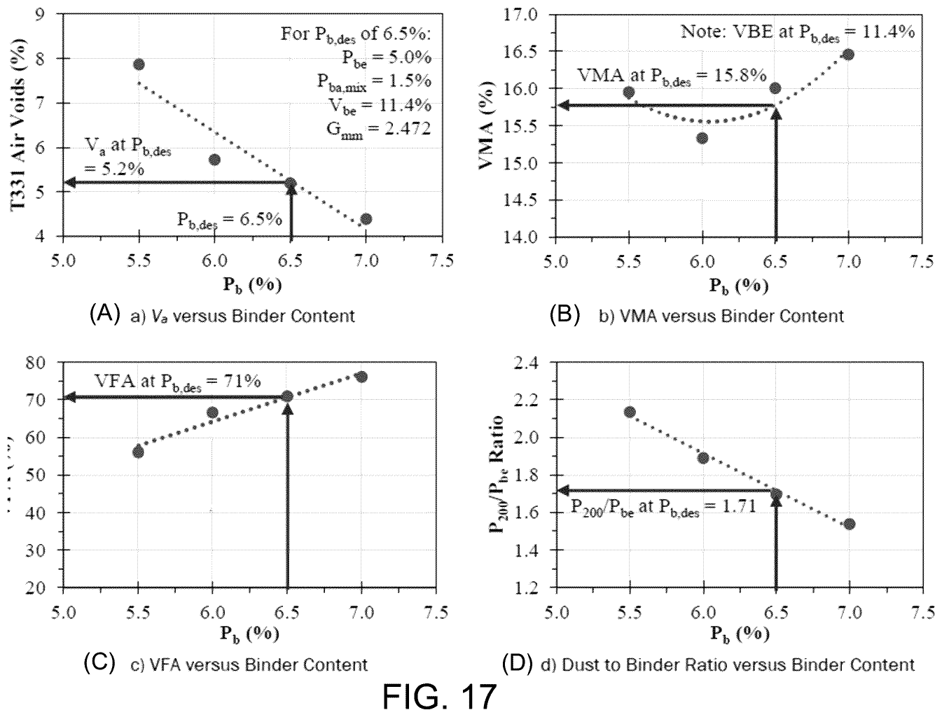

Evaluating both mechanical properties and volumetrics, design binder contents were selected that attempted to balance all properties while yielding reasonable volumetrics. FIGS. 14 to 17 chart the volumetric properties in the Table of FIG. 8 for each mix with arrows showing design values. FIG. 14 shows mix design volumetric charts of C₁ for (A) Vₐ versus Binder Content, (B) VMA versus Binder Content, (C) VFA (Voids Filled Asphalt) versus Binder Content, and (D) Dust to Binder Ratio versus Binder Content. FIG. 15 shows mix design volumetric charts of F₁ for (A) Vₐ versus Binder Content, (B) VMA versus Binder Content, (C) VFA (Voids Filled Asphalt) versus Binder Content, and (D) Dust to Binder Ratio versus Binder Content. FIG. 16 shows mix design volumetric charts of C₂ for (A) Vₐ versus Binder Content, (B) VMA versus Binder Content, (C) VFA (Voids Filled Asphalt) versus Binder Content, and (D) Dust to Binder Ratio versus Binder Content. FIG. 17 shows mix design volumetric charts of F₂ for (A) Vₐ versus Binder Content, (B) VMA versus Binder Content, (C) VFA (Voids Filled Asphalt) versus Binder Content, and (D) Dust to Binder Ratio versus Binder Content.

For both C₁ and F₁, a design binder content of 4.0% was selected. In some cases, such as APA and Hamburg testing, a case could be made for a 3.5% design binder content; however, this would result in considerably low binder contents that were deemed unsuitable. For example, volume of effective binder (VBE) would be around 5%, which is quite low for an asphalt mix (the design VBE of 6.0% to 6.6% is already fairly low). Balancing mechanical properties and volumetrics, namely overall binder volume, 4.0% design binder content was believed to be the most rational choice.

For C₂ and F₂, design binder contents of 6.0% and 6.5% were selected, respectively. In effectively all cases, increasing binder improved mechanical properties, so a case could be made for selecting 6.5 and 7.0% instead. However, BH5700 binder contents of 6.0% and 6.5% are on the upper end of typical ranges, so limiting them to 6.0% and 6.5% was believed to be a fair approach. At 10.4% and 11.8% VBE, respectively, C₂ and F₂ exhibit reasonable VBE values on par with typical HMA mixes. As with the C₁ and F₁ design binder content selections, 6.0% and 6.5% for C₂ and F₂, respectively, were believed to be the most rational choice when considering mechanical properties and volumetrics, namely overall binder volume.

It is worth pointing out that other volumetric properties in FIGS. 14 to 17 are drastically different relative to what would be considered normal or preferable for HMA. Design Vₐ and VMA values are very high for the coarse gradation, though they are more reasonable for the fine gradation. Most VFA values are out of typical specification ranges, and some dust-to-binder ratios are also extreme. These results illustrate the challenges that volumetrics can present for CMA and support the use of mechanical properties as a primary parameter for mix design.

### 3.2 Benchmarking Lab-Designed CMA Against Control Mixes

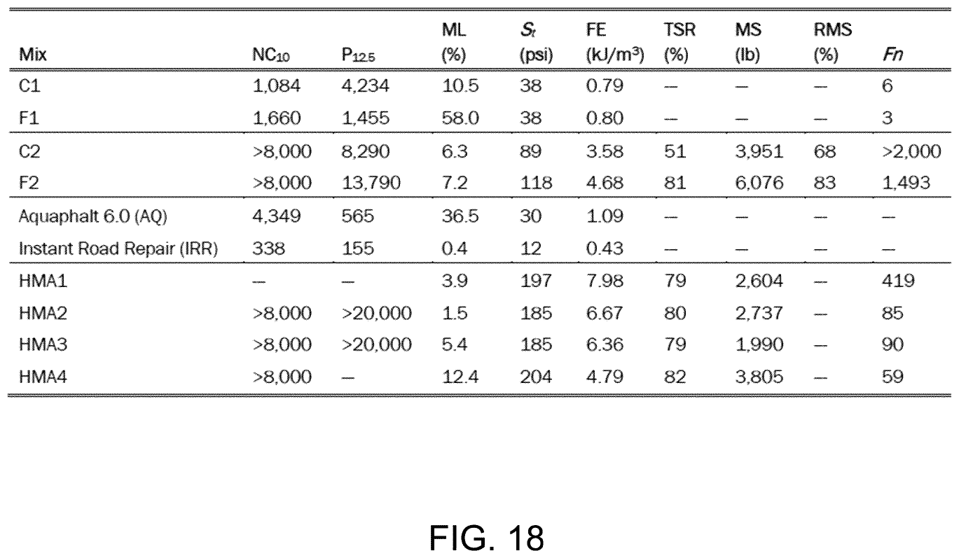

Using the established mix designs from Section 3.1, this section provides comparisons of design properties to COTS CMA control mixes as well as typical airfield HMA control mixes. Additional tests relative to those in Section 3.1 were also performed at ultimate-cure conditions (45 days at 60° C. for CPB mixes and 1 day at 25° C. for BH5700 mixes). For all CPB and BH5700 mixes, both dynamic modulus and flow number were measured; for only BH5700 C₂ and F₂ mixes, TSR, Marshall stability, retained stability, and I-FIT properties were also measured. Only Section 3.1 properties were measured for COTS CMA control mixes (1 day curing at 25° C.), but those plus most of the additional properties were measured for HMA control mixes. FIG. 18 is a Table of summary of properties for lab-designed CMA and control mixes. It summarizes most results discussed in this section except dynamic modulus and I-FIT results.

### 3.2.1 APA and Hamburg Rutting Comparisons

CPB mixes C₁ and F₁ fall in the middle of COTS CMA performance. IRR performance would likely improve given additional time to cure. Comparatively, BH5700 mixes C₂ and F₂ perform exceptionally even compared to typical airfield HMA mixes, two of which contain polymer-modified binders. Differences between APA specimens are clearly evident. Differences between Hamburg specimens are evident in a different manner; IRR and AQ specimens exhibit severe deformation, whereas F₂ and C₂ specimens exhibit considerable stripping of aggregates.

### 3.2.2 Cantabro Durability Comparisons

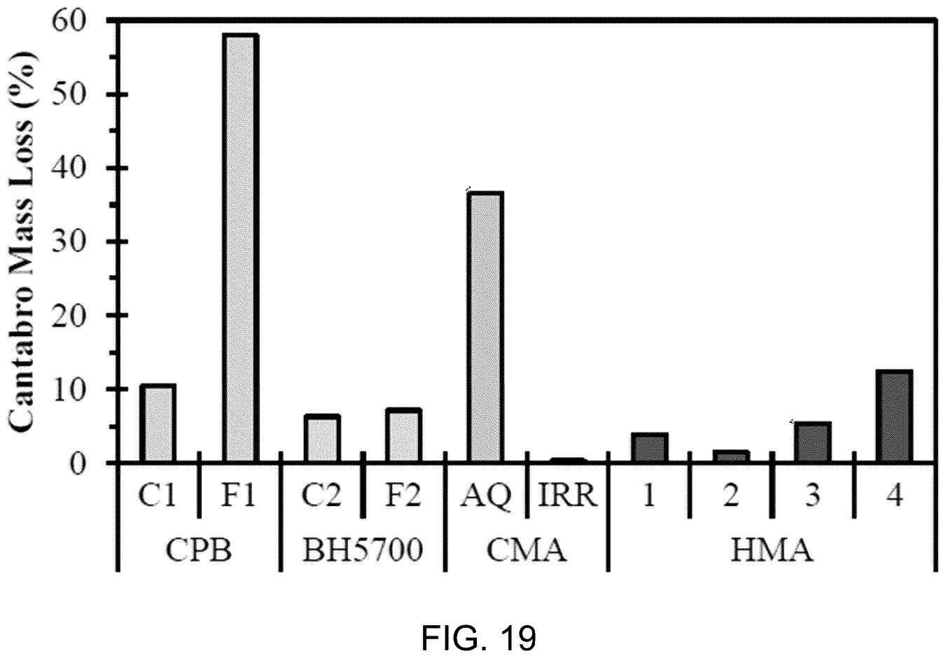

FIG. 19 presents CML (Cantabro Mass Loss) data for mixes in the Table of FIG. 8. Mass loss for AQ is considerably high, which is not unexpected; however, IRR mass loss is inexplicably low at only 0.4% and is lower than any other mix tested. Mass losses for HMA₁ to HMA₃ were all well below 10%, but HMA₄ mass loss was slightly high for an airfield mix at 12.4%. Regardless, mass losses for C₂, F₂, and even C₁ were on the order of the HMA controls.

The IRR specimen was not unaffected by the test; however, it appears that IRR specimens were soft enough to absorb all impact energy during the test and simply deform into a more spherical shape rather than retain their cylindrical shape and have pieces dislodged off them like a normal test. Following testing, all IRR specimens cracked and split and eventually fell apart simply sitting on a counter; this would not be considered a mark of mixture durability. Consequently, it appears the low mass loss values for IRR are misleading.

### 3.2.3 IDT, TSR, and Marshall Stability Comparisons

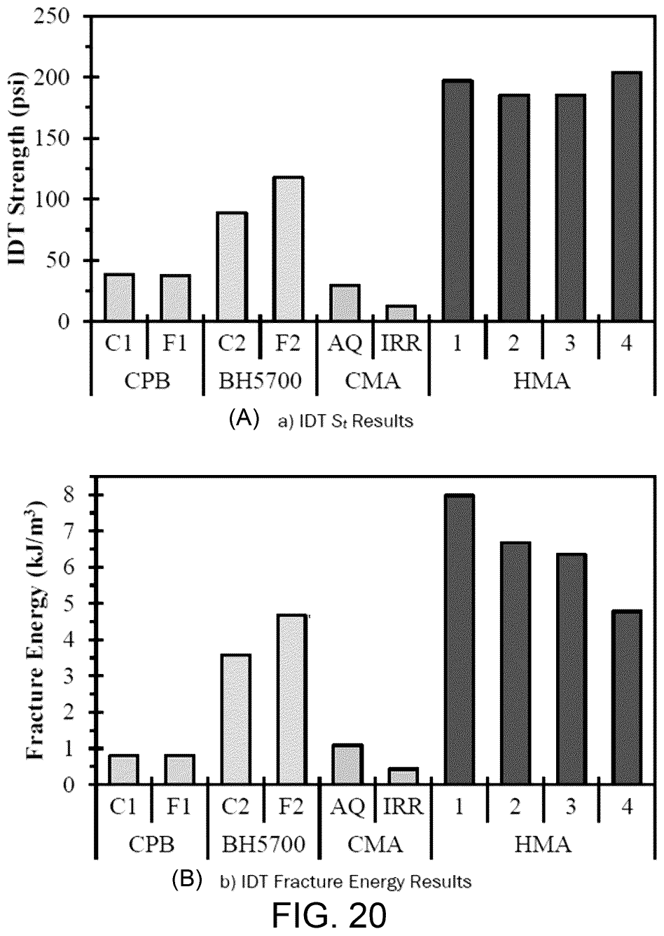

FIG. 20 is a graph showing IDT Sₜ and FE compared to control mixes for (a) IDT St results and (b) IDT fracture energy results. It presents IDT results for mixes in the Table of FIG. 18. CMA controls exhibited lower St values but similar FE values compared to C₁ and F₁. Again, it must be considered that AQ and IRR were given less time to cure, so comparisons are somewhat indirect. HMA controls exhibited considerably higher St and FE values than all other mixes at around 185 to 200 psi and 5 to 8 kJ/m³, respectively. In this regard, C₂ and F₂ St and FE are still fairly reasonable, but comparing them to HMA illustrates a gap between BH5700 CMA and typical HMA.

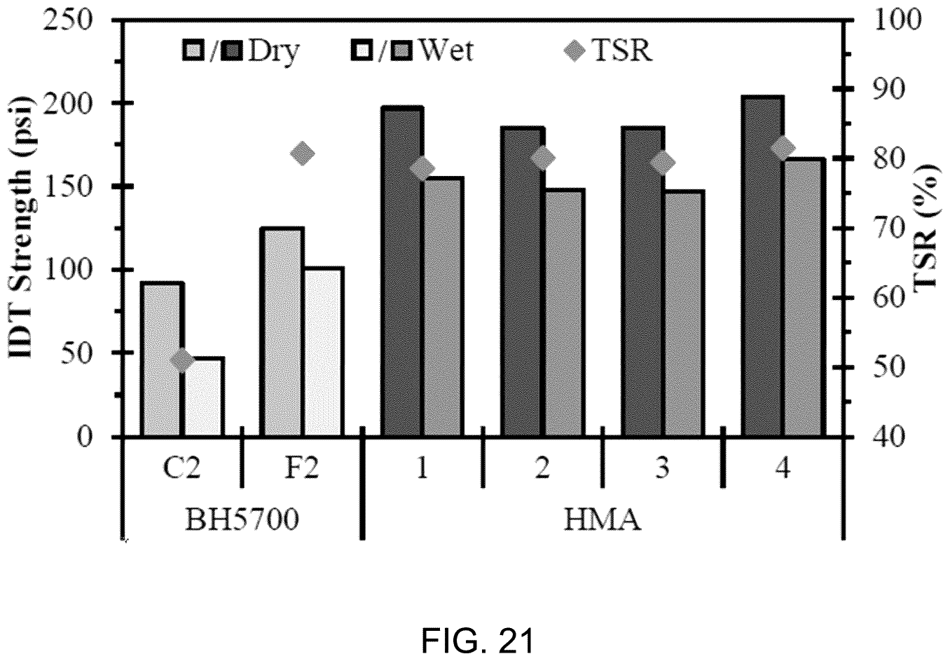

FIG. 21 is a graph showing IDT St and TSR (Tensile Strength Ratio) compared to control mixes. In general, the TSR parameter has numerous documented shortcomings; however, the fact remains that it is still a common property measured during asphalt mix design. Given the moisture damage concerns stemming from Hamburg testing, it was felt that adding TSR data, as well as MS and RMS data, would provide additional perspective to moisture-related characteristics of BH5700 CMA.

FIG. 21 shows that C₂ has a low TSR of 51%, which would fail typical HMA requirements (UFGS 32 12 15.13 [2020] requires 75% TSR minimum). F₂, however, has a more respectable TSR of 81% compared to 79% to 82% for HMA control mixes. This is likely due at least in part to F₂'s lower Vₐ of 5.5% (at 6.5% design binder and 30 design gyrations) compared to C₂'s average Vₐ of 11.8% at design conditions; this would lead to a large difference in permeability, which likely had some influence on results. While TSR is not a foolproof parameter, there is no question that a value as low as the C₂ TSR is likely concerning. It suggests that F₂ would be preferable over C₂, since all other mechanical properties presented up to this point are fairly similar.

The tested TSR specimens were examined to compare the split faces of dry- and wet-tested specimens. Relative to the dry specimens, some visible evidence of stripping is present. Visible stripping is more noticeable for C₂ relative to F₂, which aligns with FIG. 21 results.

MS and retained stability trends are similar to TSR trends for C₂ and F₂, though not quite as extreme. Stability averaged 2,684 lb for C₂ and 6,076 lb for F₂, both of which would easily meet typical HMA stability requirements (UFGS 32 12 15.13 [2020] requires 2,150 lb minimum for a 75-blow Marshall-designed mix). Retained stability was 68% and 83% for C₂ and F₂, respectively. Retained stability is a less commonly specified property; however, 70% minimum is a reasonable threshold that is often observed. At 70% minimum, C₂ just barely fails the retained stability threshold; it certainly does not fail RMS criteria as badly as it fails TSR criteria. On the other hand, F₂ comfortably passes a 70% minimum RMS criterion just as it does for TSR.

### 3.2.4 Dynamic Modulus Comparisons

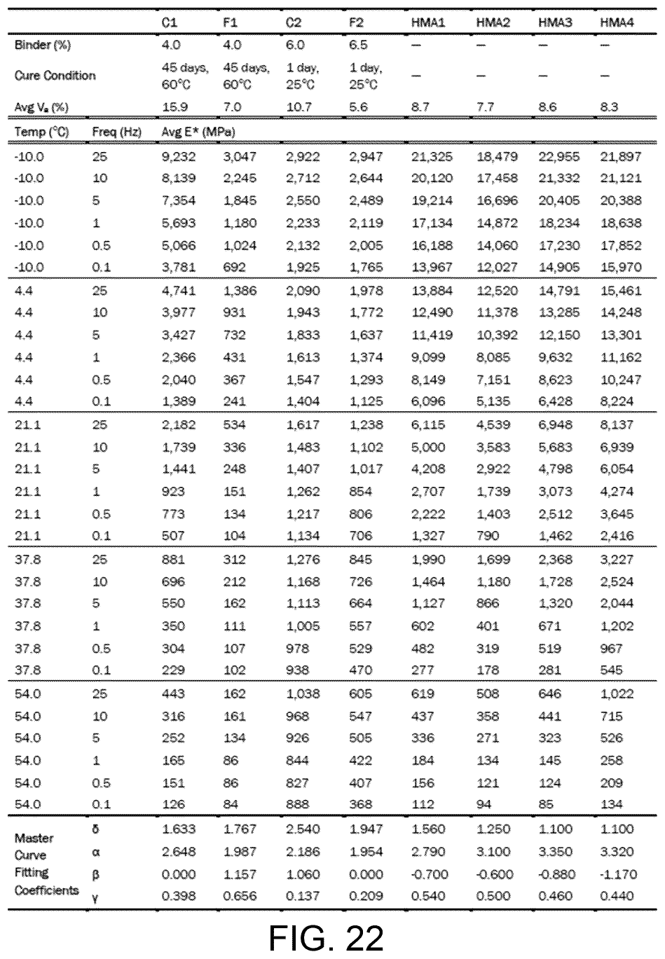

FIG. 22 is a Table of the summary of dynamic modulus results. It presents all dynamic modulus E* data for C₁, F₁, C₂, F₂, and HMA control mixes. Data are provided in table form so that all values are available; however, data are best assessed graphically. There is a lack of temperature sensitivity for BH5700 CMA. Low temperature sensitivity is a positive trait for an asphalt mixture.

By comparison to HMA control mixes, C₂ and F₂ have lower modulus values than HMA at low temperatures but actually have higher modulus values than HMA at high temperatures. CPB mixes C₁ and F₁ exhibit similar temperature sensitivity to HMA but have much lower overall modulus values across most of the frequency spectrum.

To convey typical modulus values, E* values at 21.1° C. and 10 Hz are sometimes presented. At this temperature and frequency, F₁ exhibits the lowest modulus at 336 MPa (49,000 psi). F₂ and C₂ exhibit 1,102 and 1,483 MPa (160,000 and 215,000 psi), respectively. Interestingly, C₁ is slightly higher at 1,739 MPa (252,000 psi). HMA control mixes range from 3,583 to 6,939 MPa (520,000 to 1,006,00 psi) and average 5,302 MPa (769,000 psi). It must not be overlooked that this ranking shifts at high temperatures so that C₂ and F₂ exhibit the highest modulus values of all mixes tested. Arguably, this temperature insensitivity characteristic may be more important than ranking highest at 21.1° C. and 10 Hz.

Overall, dynamic modulus and phase angle data collectively illustrate that BH5700 CMA is far less temperature sensitive than CPB CMA or typical HMA. It is a viscoelastic material like HMA, but it exhibits far more elastic behavior and far less viscous behavior than typical HMA. While modulus may be less at intermediate to low temperatures, it maintains modulus at high temperatures, which is a positive attribute for a patching mixture that is expected to withstand extreme loads.

### 3.2.5 Flow Number Comparisons

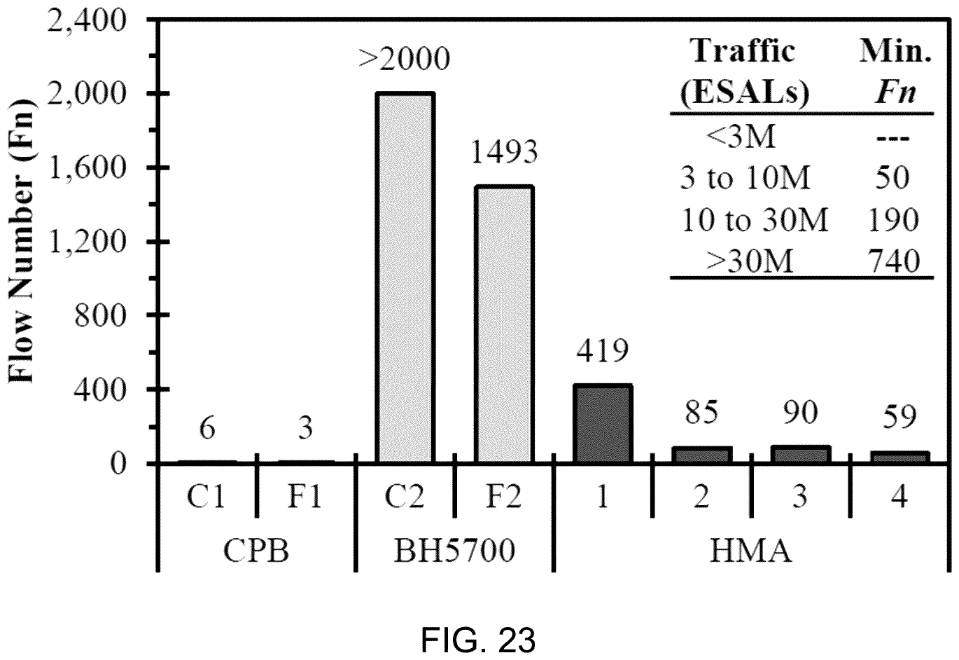

FIG. 23 is a graph of flow number (Fn) comparisons. It plots flow number results from the Table of FIG. 18 alongside recommended minimum flow numbers in AASHTO T₃₇₈ (2017) for various highway traffic levels in equivalent single axle loadings (ESALs). HMA control mixes fell into one of two performance levels. HMA₁ exhibited a flow number (Fn) of 419 (10 to 30M ESAL category) compared to HMA₂ to HMA₄, which ranged from 59 to 90 (3 to 10M ESAL category). Comparatively, CPB mixes performed poorly with flow numbers of only 6 and 3 cycles. BH5700 mixes performed exceptionally with average flow numbers of >2,000 and 1,493, which far exceed the 30M ESAL threshold in T₃₇₈.

Representative specimens from C₁, C₂, HMA₁, and HMA₂ are compared to illustrate the different behaviors during flow number testing. HMA₁ and HMA₂ represent typical HMA flow number curves. By comparison, C₁ failed very quickly. However, C₂ accumulated negligible permanent strain throughout the test, and by 2,000 cycles (programmed as a test termination point in the PaveTest DTS-130 control software), the curve remains flat, and it does not appear that an inflection point (i.e., Fn) would occur for many more cycles. Overall, flow number data affirm the highly elastic behaviors of BH5700 CMA that indicate it has meaningful rutting and stability implications relative to CPB CMA or even typical HMA.

### 3.2.6 I-FIT Cracking Comparisons

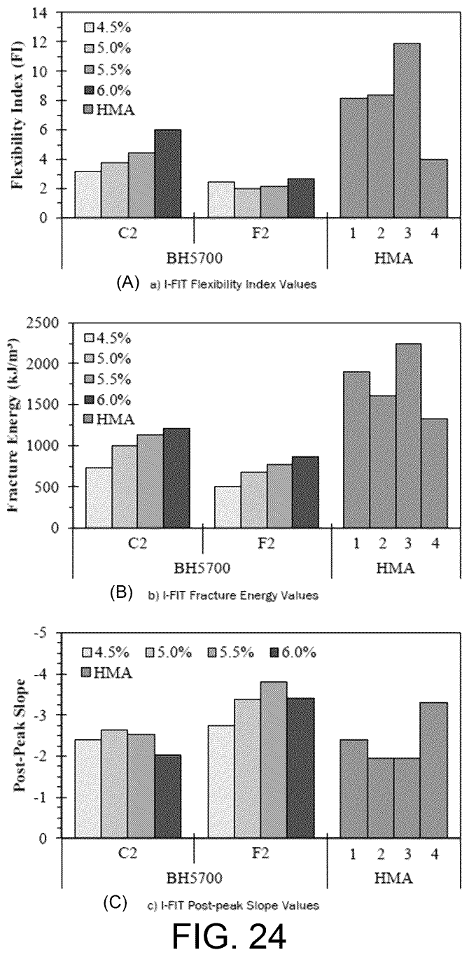

FIG. 24 shows graphical plots of I-FIT results for C₂, F₂, and HMA control mixes for (A) I-FIT flexibility index (FI) values, (B) I-FIT fracture energy values, and (C) I-FIT post-peak slope values. Note that I-FIT data for C₂ and F₂ were collected using trial specimens that were mixed at ambient temperature (i.e., specimens were prepared identically to other specimens in Section 3). Binder content ranged from 4.5% to 6.0%, and all available data are presented.

Flexibility index (FI) values in FIG. 24 range from 4.0 to 11.9 for HMA control mixes. They range from 2.0 to 6.0 for C₂ and F₂ specimens, depending on the binder content. However, extreme care must be taken when interpreting results because Vₐ levels for C₂ and F₂ are considerably different from the HMA control mixes and, likewise, the Vₐ target that AASHTO TP₁₂₄ (2020a) specifies (7.0% Vₐ by AASHTO T₁₆₆ [2016] basis, or approximately 8.0% Vₐ by AASHTO T331 [2013] basis).

For HMA, FI, which is an index property, has been shown to increase (i.e., cracking resistance is improved) when Vₐ increases at least up to 10%, which is not rational. Most C₂ and F₂ Vₐ levels in FIG. 24 are above the TP₁₂₄ (AASHTO 2020a) target; C₂ ranges from 10.1% to 14.7%, and F₂ ranges from 5.7% to 12.7% (T331 [AASHTO 2013] basis), depending on the binder content. Whether the effect of Vₐ deviations on BH5700 CMA is the same as for HMA is unknown, but because of these uncertainties, the data should be interpreted with caution.

I-FIT data were collected primarily out of curiosity and because specimens prepared were valid specimens not allocated for any other purpose. It was decided to make use of them by exploring I-FIT testing. Ultimately, the wide range of Vₐ values relative to the TP₁₂₄ (AASHTO 2020a) requirement poses enough uncertainty that these data, particularly FI, should be used for informational purposes only.

### 3.3 CMA Short-Term-Cure Properties

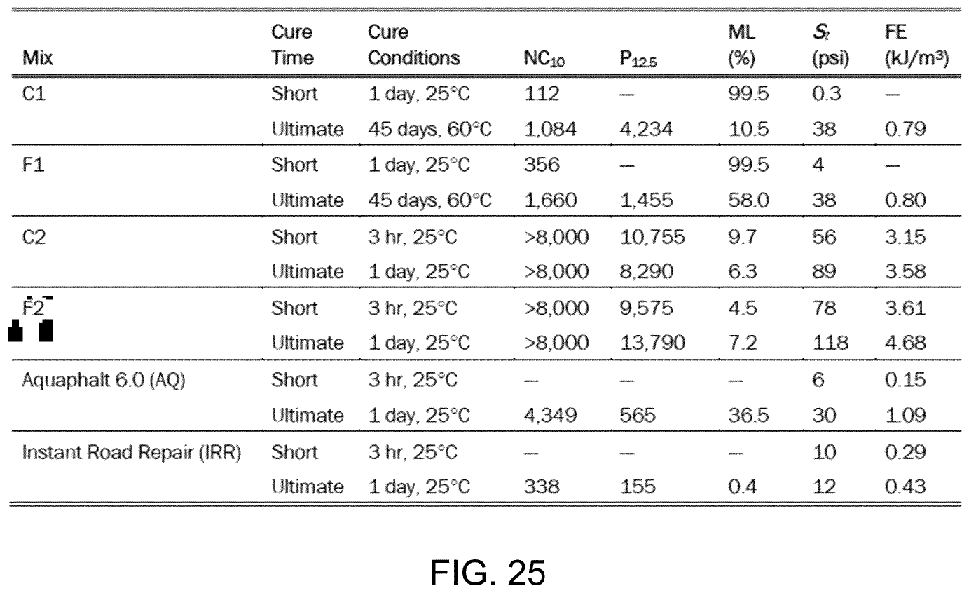

This section focuses on the sensitivity of CMA mechanical properties to cure time. C₁ and F₁ mixes that were cured 45 days at 60° C. for ultimate properties were short-term cured for 1 day at 25° C., which also provides a direct comparison to C₂, F₂, and CMA control mixes. Short-term curing for C₂, F₂, and CMA control mixes was performed for 3 hr at 25° C. FIG. 25 is a Table of summary of short- and ultimate-cure CMA properties. It summarizes properties where tests were performed at both short- and ultimate-cure conditions.

Note that not all tests were performed for all mixes at the short-term-curing condition. Hamburg tests could not be performed on C₁ and F₁ because specimens would not withstand handling and sawing. Comparing CPB and BH5700 mixes was of primary interest; so for AQ and IRR, only IDT tests were performed at the short-term-cure time.

### 3.3.1 Short- Versus Ultimate-Cure APA Rutting Properties

For C₁ and F₁, rutting performance noticeably worsened, although it was already less than optimal even after 45 days of curing at 60° C. APA results for C₂ and F₂ were for all practical purposes the exact same at 3 hr of curing as at 1 day. This is encouraging for quick return-to-traffic times for BH5700 CMA but is the opposite for CPB.

### 3.3.2 Short- Versus Ultimate-Cure Hamburg Rutting Properties

Although there are some apparent differences in the P_{12.5} data in the Table of FIG. 25, those differences are likely the result of variability throughout the stripping portion of the rutting curve more so than true/repeatable differences. As with APA results, there are no meaningful differences in Hamburg results whether the specimens were cured for 3 hr or 1 day. Because BH5700 Hamburg results were already somewhat suspect with respect to moisture damage, it is encouraging that Hamburg results did not worsen when cure time was reduced.

### 3.3.3 Short- Versus Ultimate-Cure Cantabro Durability Properties

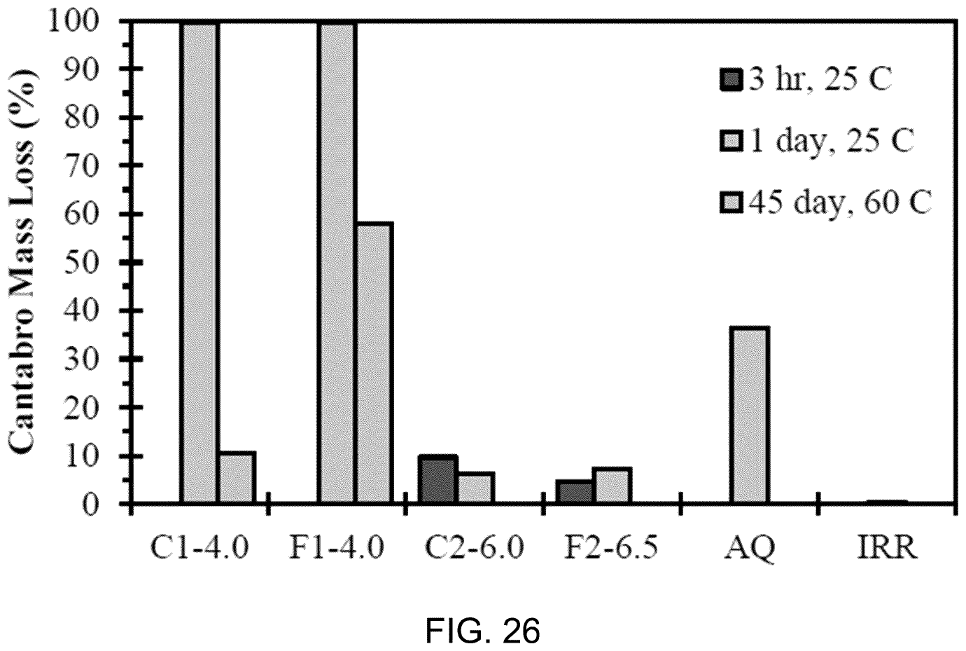

FIG. 26 is a graph of CML comparison of ultimate and short-term curing. It plots CML results for each cure time. F₁ mass loss was excessive at ultimate cure while C₁ mass loss was reasonable; however, both F₁ and C₁ exhibited complete mass loss after short-term curing. For both mixes, specimens disintegrated within the first few revolutions of the LA Abrasion drum. On the other hand, C₂ and F₂ fared favorably, with mass loss values being approximately the same whether curing was performed for 3 hr or 1 day.

### 3.3.4 Short- Versus Ultimate-Cure IDT Strength Properties

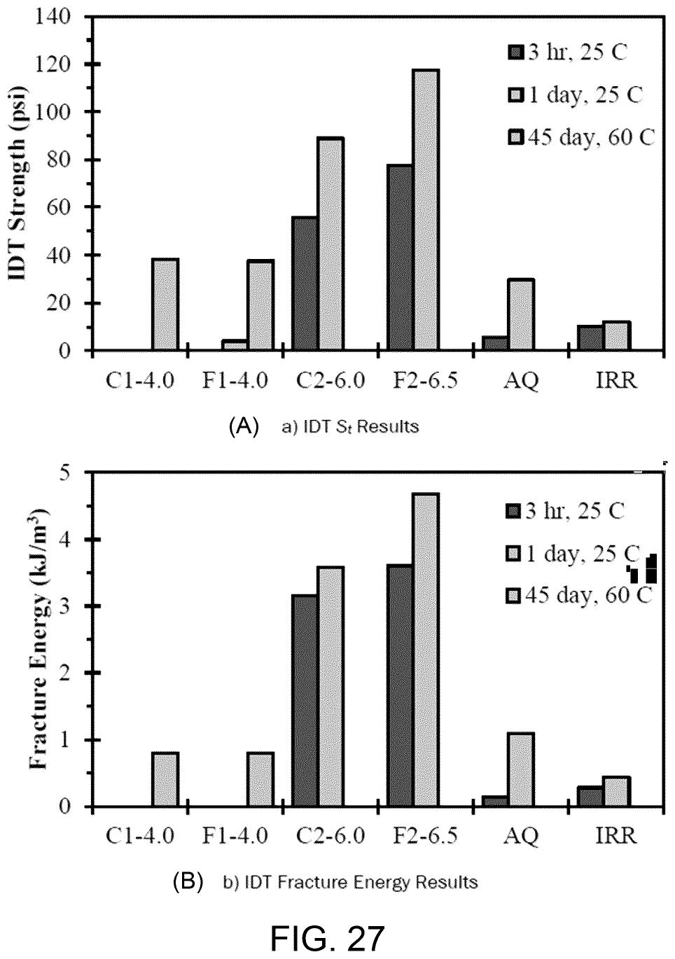

FIG. 27 shows graphs of IDT comparison of ultimate and short-term curing for (a) IDT St results and (b) IDT fracture energy results. They show plots of IDT St and FE values for short and ultimate cure times. CMA control mix IRR effectively exhibited the same St and FE at 3 hr as at 1 day; however, AQ St and FE were dramatically reduced. For C₁ and F₁, St was reduced to negligible values of 0.3 and 4.0 psi (FE was not calculated). C₂ and F₂, however, retained much of their original St and FE but did experience moderate reductions of 34% to 37% for St and 12% to 23% for FE.

### 3.3.5 Short-Term-Curing Summary

Results in this section clearly show a major shortcoming of lab-designed CPB mixes and also, to some extent, CMA control mixes. While C₁ and F₁ sometimes exhibited reasonable properties at ultimate cure (e.g., 10% CML for C₁), these positive attributes were few and far between at 45 days of 60° C. curing and quickly faded when curing was reduced to 1 day at 25° C. When placed in a level curing condition as C₂ and F₂ (i.e., 1 day at 25° C.), the drastic performance gap between CPB and BH5700 became even more pronounced. However, for the most part, C₂ and F₂ performances did not unmanageably decrease when cure time was reduced from 1 day at 25° C. to only 3 hr. Some reductions in IDT St and FE were observed, but the percent reduction was much less than that of AQ, and the actual St and FE values were still much higher than those of AQ or IRR. Overall, BH5700 CMA exhibits considerable promise as a high-quality patching material relative to existing alternatives.

### 4. Field Results

### 4.1 Patching Operations

Full-scale field testing was performed on Sep. 9, 2021. The temperature was around 75° F., and wind conditions were fairly breezy. Lab-designed CMA mixes F₁, C₂, and F₂ were tested alongside AQ, IRR, and HMA₁ control mixes. Prior to the day field patching was conducted, the test section had been prepared. Patching operations began at 11:49 and ended at 14:43, for a total of just under 3 hr to place 10 patches. Patches were then given 3 hours from the completion of Patch 10 before trafficking was started.

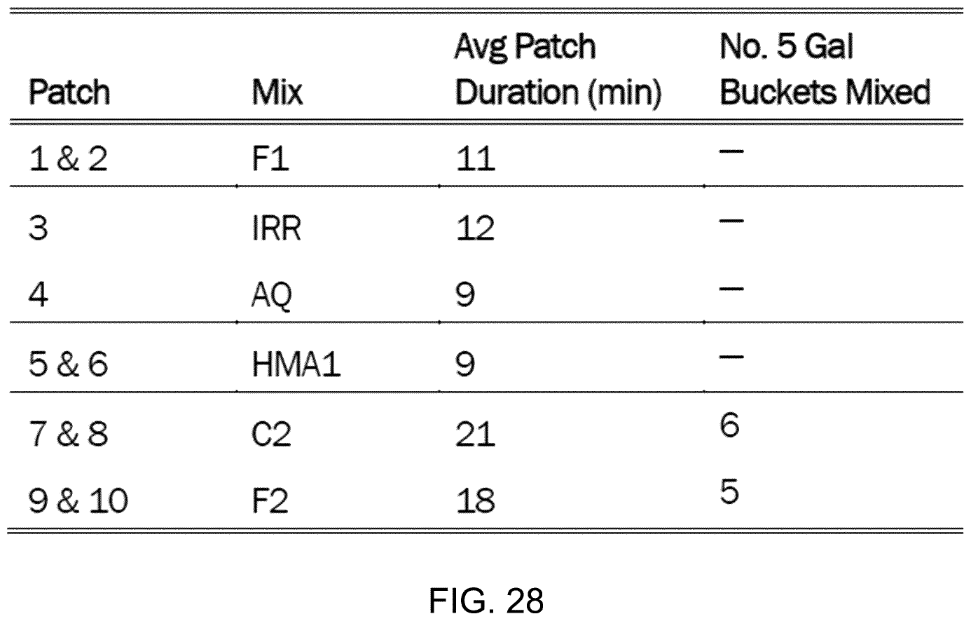

FIG. 28 is a Table of field patching times and quantities. The Table provides average patch times for each mix type, not including any down time between patches. The average patch time is from the time the mix was first dumped from the bucket until compaction of the second lift was complete. For F₁, IRR, AQ, and HMA₁, average patch time was 9 to 12 minutes. For C₂ and F₂, patching times approximately doubled, since BH5700 Part B had to be mixed in on-site. For Patches 7 and 8, a total of six C₂ buckets were mixed, although only a fraction of the sixth bucket was needed. For Patches 9 and 10, five F₂ buckets were mixed and used.

Field patching went smoothly with few issues, but there were several items to note. Rather than prebatching the correct BH5700 Part B dosage in individual containers, Part B was dosed on-site using a portable scale. Due to windy conditions that day, it was difficult to maintain stable scale readings, even with a wind screen. This undoubtedly led to some amount of variability in the Part B dosage relative to lab mixing. Additional time was taken to weigh Part B as accurately as possible; and, although it was more variable than lab mixing, it was believed that actual Part B dosages were within reason relative to the target dosages.

During field mixing, it was noted that C₂ exhibited more workability than F₂ and was easier to shovel mix. Given the gradation differences, this observation was not surprising. It is one of the common reasons that coarse gradations are used for CMAs. Workability of F₂ was not a major challenge, but it did appear that it was more difficult to ensure adequate mixing in of BH5700 Part B. After performing the field-mixing operations, it is believed there may be benefit to increasing the Part B dosage even higher than 4.0% to perhaps 4.5% or 5.0%. Additional work would be needed to determine the impacts, positive or negative, of different Part B dosages for field mixing.

### 4.2 F-15E Traffickinq

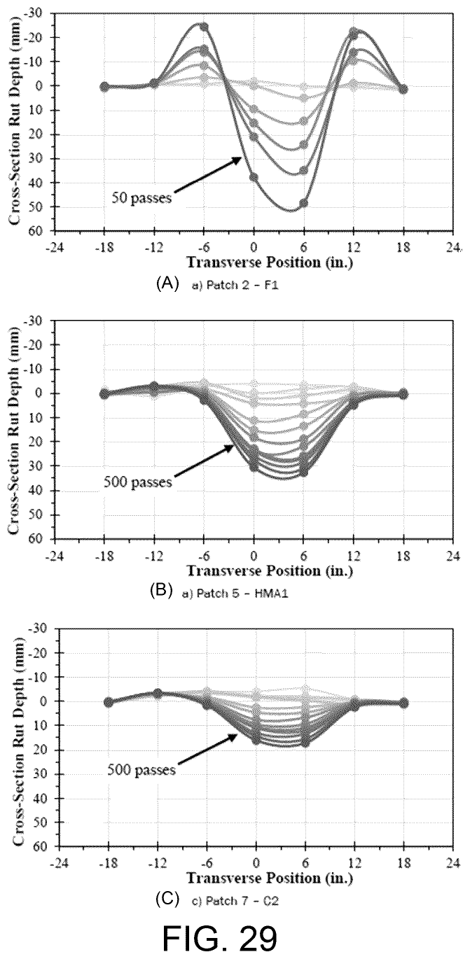

FIG. 29 shows graphical plots of examples of patch cross sections throughout trafficking for (a) Patch 2-F₁, (b) Patch 5-HMA₁, and (c) Patch 7-C₂. They show three examples of rutting progression throughout trafficking for poor, moderate, and good rutting performance. The lightest line is the original baseline patch profile at 0 passes, and the darkest line is the last pass recorded (50 passes for FIG. 29(a) or 500 passes for FIGS. 29(b) and 29(c)). Considerable upheaval is observed in FIG. 29(a) in addition to considerable rutting. For ease of comparison, all three plots are scaled identically.

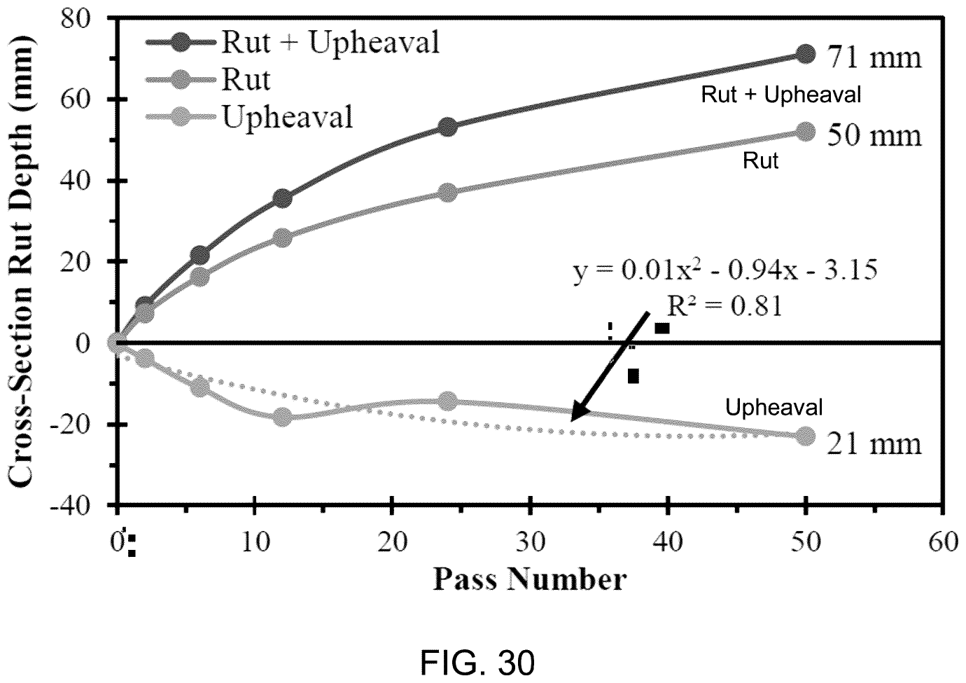

FIG. 30 is a graphical plot of illustration of total rut calculation for Patch 2 (F₁). It illustrates the rutting profiles for Patch 2 (F₁) throughout trafficking and is useful for understanding rut calculations. The maximum wheel path rut depth after 50 passes is 50 mm, whereas the total upheaval is 21 mm. The total rut depth is defined as the permanent rutting deformation in the wheel path plus the upheaval; for Patch 2, this equates to 71 mm. Note the polynomial trendline on the upheaval curve. Upheaval measurements tended to be more variable, which translated to total rut curves that appeared erratic; therefore, a polynomial fit was applied to upheaval curves during this data analysis phase to average out modest variability.

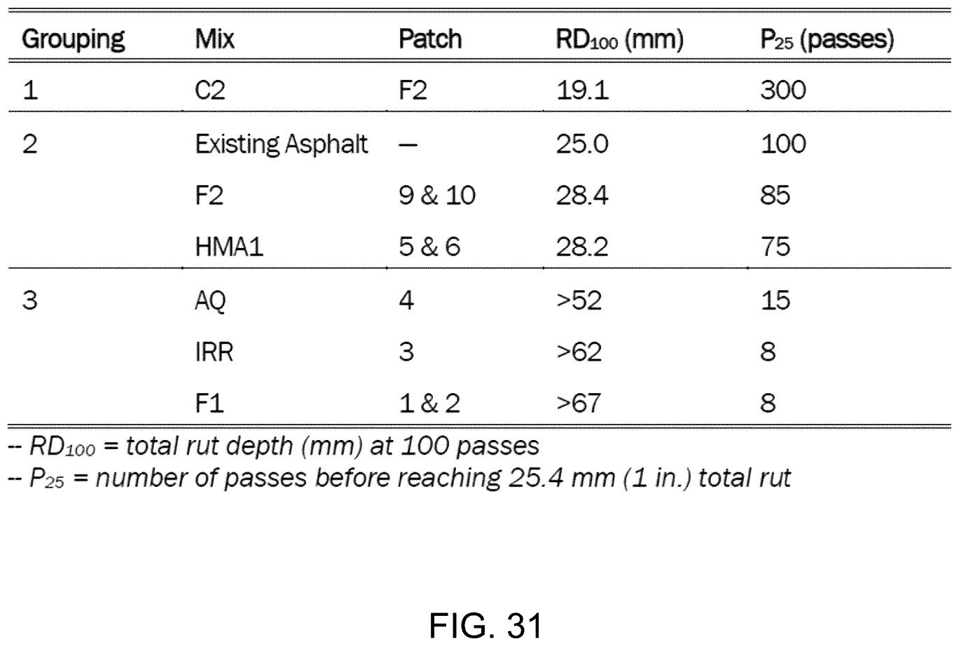

FIG. 31 is a Table of average field rutting results under simulated F-15E traffic. It summarizes data for rut depth at 100 passes (RD100) and number of passes to 25.4 mm total rut (P25). Results can be grouped into three distinct performance groupings. For group 3 (worst performance), F₁, IRR, and AQ all exceeded 25.4 mm of rutting within a few passes (8 to 15) and were not greatly distinguishable from one another. For group 2, HMA₁ and F₂ crossed the 25.4 mm rutting threshold at 75 and 85 passes, respectively. C₂, standing alone in group 1, withstood 300 passes prior to reaching 25.4 mm.

While the F-15E load cart was being positioned prior to trafficking, it visibly rutted the existing test section pavement. Consequently, it was anticipated that significant rutting would accumulate in the existing pavement during trafficking. In response, two cross-section measurements on the existing asphalt pavement were also recorded at each pass interval. One cross section was located 6 ft away from Patch 10 but still in the trafficked area; the other was located between Patches 5 and 6 in the middle of the trafficking area. The average rutting data at these two existing asphalt cross sections are shown in the Table in FIG. 31. Interestingly, the existing asphalt rutted alongside F₂ and HMA₁ in the second performance grouping and was outperformed by C₂.

C₂ withstood 3 to 4 times as many passes as the second group, including HMA₁, F₂, and the existing pavement. Relative to the third group, C₂ withstood 20 to 38 times as many passes as F₁, IRR, and AQ.

Altogether, there were few surprises in the ranking order of mixes. It was expected that F₁ would fail first, followed by IRR then AQ. It was generally expected that HMA₁, C₂, and F₂ would perform fairly similarly, but it was also expected that F₂ might perform better than C₂. This theory was based on lab results where C₂ and F₂ were very similar, as defined by APA testing; but F₂ slightly edged out C₂ based on Hamburg, Cantabro, and IDT testing. The perceived advantage that F₂ had was slight and was only speculation.

A possible explanation for C₂'s performance advantage in the field test may relate to the workability challenges with F₂. As noted in the previous section, it was modestly more difficult to mix F₂ with the Part B activator, which likely led to less uniform incorporation of Part B and negatively affected F₂'s curing reaction. This further reinforces the need to investigate higher Part B dosages at full scale.

Considerable rutting is visible after trafficking 100 passes. Upheaval is also visible in some cases. Shallower basins are visible, which is typically indicative of base course rutting being the leading factor in rutting measured on the pavement surface. In one of the cross-section locations where rut measurements were recorded on the existing asphalt pavement; rutting of over 1 in. (about 28 mm) is visible on the folding rule after 100 passes.

Overall, field testing successfully demonstrated the concept of BH5700 CMA, which was a previously untested material in this manner. Most notably, it was shown that a two-part CMA can be utilized in the field without requiring special equipment like a portable mixer. With nothing more than standard shovels, BH5700 CMA can be mixed on-site, used to make a patch repair, and then withstand F-15E traffic in a matter of hours.

A key takeaway from the field test is that workability should be reevaluated if a fine gradation is desired. If this can be overcome to ensure uniform mixing with BH5700 Part B, then it is likely that F₂ would have performed more in line with C₂. Another takeaway is that bonding between BH5700 CMA and conventional asphalt should be investigated to understand mechanisms causing debonding and to understand if this can be overcome by utilizing tack coat.

### 5. Discussion of Results

This disclosure details a new type of high-quality cold mix using asphalt-modified polyurethane binder. Relative to past proprietary cold mix evaluations at ERDC and observations regarding cold mix characteristics and performance in literature, the new BH5700 CMA developed in this research project far outperforms typical cold mixes. Between lab and field testing, it even demonstrated the ability to perform comparably or, in some cases, better than polymer-modified airfield HMA mixtures. This represents a major advancement in cold mix research, and this section provides discussion around several key areas.

### 5.1 Approach of Study

This research project/study acknowledges that testing typical CMAs with HMA-type protocols will make most CMA materials appear to perform quite poorly, but the choice to do that in this study was intentional. Consider that test parameters and pass/fail thresholds set for HMA are generally based on what will yield desired field performance in a given environment and under certain traffic conditions. Those environment and traffic conditions do not change simply because a cold mix patch was placed in an existing pavement. If high-quality and long-lasting performance is expected of the patch material, then it should be designed, tested, and evaluated under similar conditions as the HMA surrounding the patch. To put it informally, the F-15E wheel is indifferent to the material under it; the wheel will apply 35,235 lb at 325 psi tire pressure whether it is on top of an HMA pavement or a CMA patch.

By taking this approach, results in Sections 3 and 4 show that typical CMAs such as C₁, F₁, IRR, and AQ perform quite poorly via many of the tests that were performed. In some cases, performance is so poor at HMA-type testing parameters that performance between mixes cannot really be distinguished. For example, the flow number (Fn) for C₁ and F₁ were 6 and 3, respectively; those numbers are so low that there is no practical significance to the fact that C₁ has twice the Fn of F₁. However, the approach in this study helps to show where each material truly stands with respect to airfield-quality HMA.

### 5.2 BH5700 Performance Relative to Typical CMAs

Section 3 shows that, even at modest cure times, BH5700 mixes C₂ and F₂ exhibit noticeably more favorable performance properties relative to CPB mixes C₁ and F₁, even though CPB mixes were subjected to near-best-case curing conditions of 45 days at 60° C. This was supported by all tests performed in the lab—including APA and Hamburg wheel tracking, CML, IDT strength, dynamic modulus, and flow number.

An interesting observation in Section 3.1 is that all mechanical tests indicated that CPB binder content needed to be further reduced in order to improve mechanical properties. This suggests that the binder contents tested are all past the optimum value. However, from a practical standpoint, the 4.0% design binder content selected for both C₁ and F₁ is already on the lower end of reasonable ranges, so further reducing binder content is not likely the best path forward. In contrast, all mechanical tests showed BH5700 properties improved with binder content and never appeared to reach an optimum or upper limit. This suggests there may have been capacity to increase BH5700 binder contents to even higher levels than those evaluated, although there may be other reasons not to do so, such as cost or volumetrics.

Typical CMAs such as C₁ and F₁ are particularly sensitive to cure time and temperature. Recall that C₁ and F₁ specimens could not be extruded from gyratory molds and cured without the plastic confining sleeves, or else they would collapse. After a fairly generous curing period of 45 days at 60° C., C₁ and F₁ specimens were more than stable enough to handle and test, yet mechanical properties were not optimal. When cured for only 1 day at 25° C., CPB performance went from marginal to abysmal. In contrast, BH5700 mixes were tested with 1 day at 25° C. curing, being the default curing method in this project; and mechanical properties were considerably better than those of CPB mixes. Reduction of curing time to only 3 hr had little effect on most BH5700 mix properties. The most discernable change was that IDT strength decreased by about one third.

Although the proprietary CMA controls AQ and IRR generally performed better than C₁ and F₁ under equivalent curing conditions, BH5700 mixes C₂ and F₂ meaningfully exceeded both AQ and IRR with respect to every mechanical property. Overall, BH5700 mixes were preferable in all areas considered: rutting, moisture susceptibility, durability, strength, and fracture properties. This trend was only further reinforced in Section 4 during full-scale field testing.

### 5.3 BH5700 Performance Relative to Typical HMAs

With respect to conventional rut testing, as measured by APA testing, not only did BH5700 mixes perform better than typical CMAs, but they performed noticeably better than airfield HMA control mixes. This is a significant accomplishment.

With respect to Hamburg wheel tracking where water was present, BH5700 mixes fell short relative to the HMA control mixes, which only slightly rutted. It is worth noting that despite the shortcomings relative to HMA, all BH5700 mixes would normally be considered acceptable based on P_{12.5} criteria. However, all BH5700 mixes exhibited fairly early onset stripping, which is not ideal. Of course, this is based on typical HMA metrics, which would be of interest for permanent repairs; but for contingency operations, BH5700 mixes did withstand 4,000 to 6,000 passes before stripping began. That would likely be acceptable for contingency use.

Even though HMA control mix performance was not poor with respect to dynamic modulus and flow number, BH5700 mixes performed exceptionally by comparison. Both tests illustrated the highly elastic nature of BH5700 and the overall lack of temperature sensitivity relative to typical HMA.

Overall, both lab and full-scale field results showed that BH5700 mixes possess the ability to perform near the level of typical airfield HMA or even above in some cases. The most obvious concern with BH5700 mixes moving forward is the moisture susceptibility.

### 5.4 BH5700 Field Applications

Full-scale field testing of the BH5700 mixes C₂ and F₂ was fairly successful, especially for C₂, which outperformed even the existing asphalt pavement by a factor of three under F-15E traffic. Being the first field trial of this type of cold mix, there were several important takeaways.

The first, and probably most important, observation from field testing is that not only does the BH5700 concept work in the laboratory where mixing is more readily controlled, but also it works in the field with reduced mixing effort using only shovels. Because BH5700 mixes do require the addition of an activator, it was important to the researchers that the decision to utilize a two-part binding system did not result in the need to take dedicated mixing equipment to the field. This is not to say that mixing equipment of some sort could not be used, but the researchers did not want it to be a requirement. The use of dedicated mixing equipment would likely decrease repair times, reduce manual labor for maintenance crews, and promote more thorough mixing of BH5700 Parts A and B.

Because the BH5700 activator had to be mixed, repair times were increased in field testing relative to typical CMA or HMA repairs. As this was the first field test, repair timing efficiency was not a first order priority, and it is expected that repair times could be optimized to some extent with additional experience with the BH5700 mixes as well as improved coordination of repair logistics. Even without optimization, it is important to maintain perspective and remember that, while BH5700 did increase repair times from around 10 to around 20 min, it provided 20 to 38 times the patch life when comparing C₂ to F₁, IRR, or AQ. This seems to be a worthwhile tradeoff.

### 6. Conclusions

1. BH5700 asphalt-modified polyurethane can successfully be used as a binder for high-performance cold mix. The concept was demonstrated from laboratory to full scale and shows promise meriting continued development.

2. In terms of mechanical properties, BH5700 cold mixes were across the board favored over ERDC-designed cold mixes or COTS CMA control mixes. BH5700 cold mixes were comparable to or better than HMA control mixes in most cases, with the exception of moisture-damage related properties.

3. Rutting performance with respect to Asphalt Pavement Analyzer (APA) testing was a notable highlight for BH5700 cold mix. Rutting of only around 1 mm at 8,000 cycles was observed under airfield testing conditions (250 psi hose pressure, 250 lb wheel load). Typical airfield criteria require less than 10 mm rutting at only 4,000 cycles.

4. Dynamic modulus and phase angle illustrated significantly less temperature sensitivity and more elastic-dominated behaviors for BH5700 cold mixes than for CMA or HMA mixes.

5. Flow numbers were around 1,500 to >2,000 for BH5700 cold mixes, which exceeded HMA control mixes (flow numbers from 59 to 419) and far exceeded CMAs (flow numbers from 3 to 6).

6. Durability as measured by CML was around 7% for BH5700 mixes, which was on the order of HMA controls (1.5% to 12.4%) and far exceeded CMAs (mass losses up to 58% at design binder contents and after 45 days of curing at 60° C. or 99.5% at equivalent cure times of 1 day at 25° C.).

7. IDT strength was moderately lower for BH5700 mixes at 89 to 118 psi compared to HMA controls at 185 to 204 psi, but it was still much higher compared to CMAs (38 psi after 45 days of 60° C. curing, 0.3 to 4 psi at equivalent cure times of 1 day at 25° C.).

8. Collectively, moisture damage resistance of BH5700 cold mixes was moderate but not optimal. Hamburg results were better than for conventional CMAs but noticeably worse than for HMA controls. While P_{12.5} for all BH5700 mixes was greater than 5,000 passes (a common pass/fail threshold), all mixes exhibited stripping at early pass levels. TSR results varied, with one BH5700 mix yielding 81% (in line with HMA controls which ranged from 79% to 82%) and the other yielding only 51%.

9. BH5700 cold mixes exhibited rapid curing properties where behaviors described in the preceding seven conclusion points were achieved after only 1 day of 25° C. curing. Even for early curing investigations at only 3 hr of 25° C. curing, properties were nearly identical, with the exception of IDT strength, which was reduced by approximately one third. In contrast, conventional CMAs exhibited considerable cure time dependence and poor performance at early cure times.

10. For full-scale field testing where patches were subjected to simulated fully loaded F-15E aircraft traffic beginning 3 hr after placement, BH5700 mixes performed comparable to or better than HMA and far better than conventional CMAs. With a 1 in. (25.4 mm) rutting failure threshold, CMAs withstood 8 to 15 passes, HMA (including the existing pavement) withstood 75 to 100 passes, and BH5700 mixes withstood 85 or 300 passes for the fine- and coarse-graded mixes, respectively. The coarse-graded BH5700 mix performed 3 to 4 times better than HMA and 20 to 38 times better than conventional CMAs.

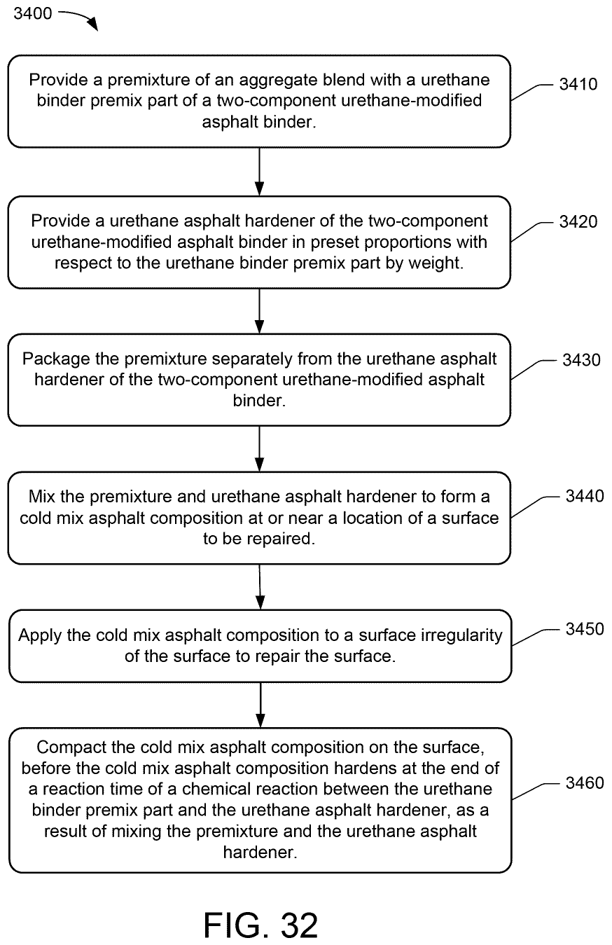

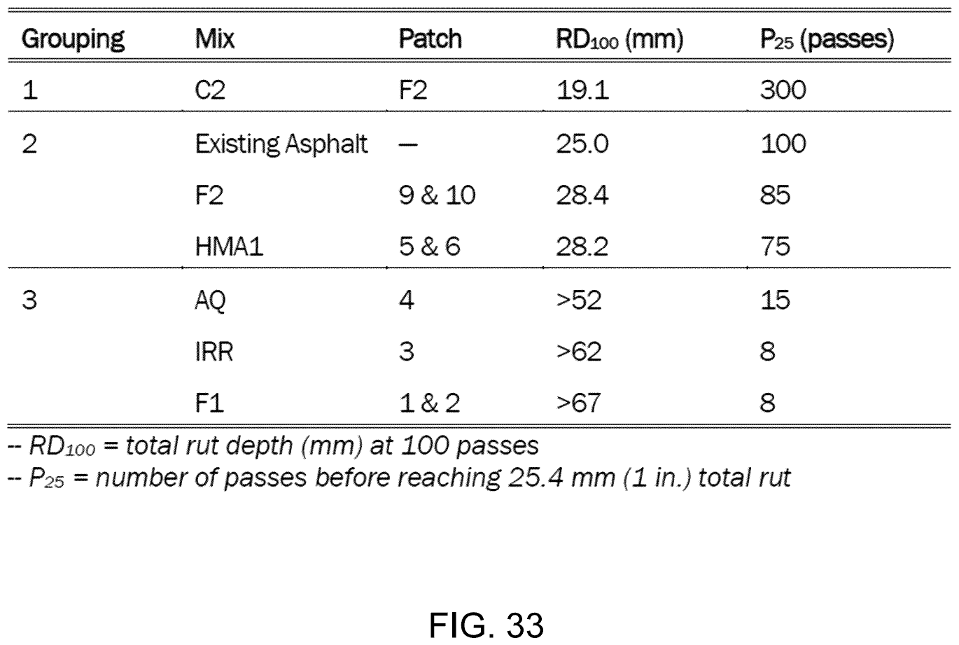

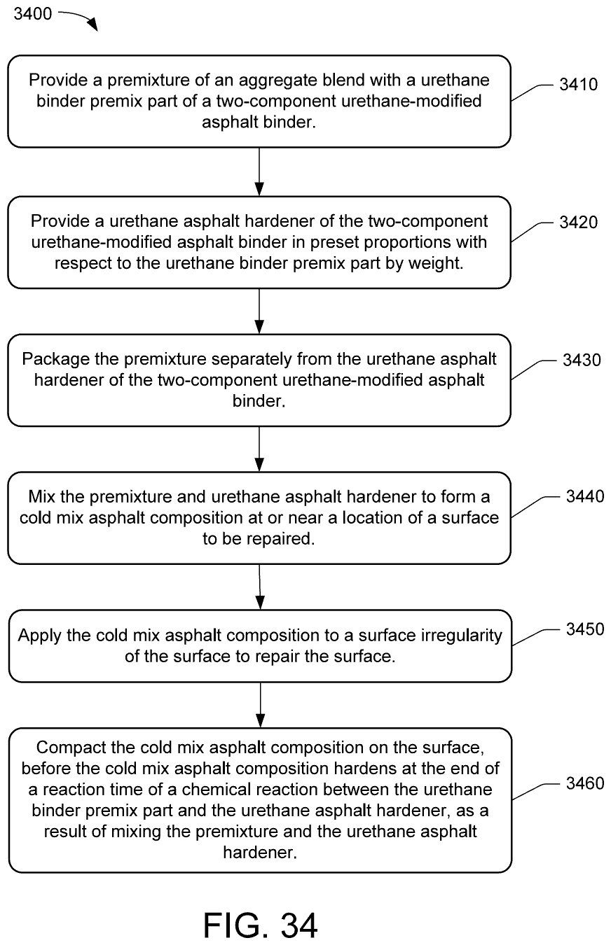

FIG. 32 is a flow diagram illustrating an example of a method of making and using a cold mix asphalt composition 3400. Step 3410 provides a premixture or an initial mixture of an aggregate blend with a urethane binder premix part of a two-component urethane-modified asphalt binder. Step 3420 provides a urethane asphalt hardener of the two-component urethane-modified asphalt binder in preset proportions with respect to the urethane binder premix part by weight. Step 3430 packages the premixture separately from the urethane asphalt hardener of the two-component urethane-modified asphalt binder. In step 3440, the premixture and urethane asphalt hardener are mixed to form a cold mix asphalt composition at or near a location of a surface to be repaired. In step 3450, the cold mix asphalt composition is applied to a surface irregularity of the surface to repair the surface. Step 3460 involves compacting the cold mix asphalt composition on the surface, before the cold mix asphalt composition hardens at the end of a reaction time of a chemical reaction between the urethane binder premix part and the urethane asphalt hardener, as a result of mixing the premixture and the urethane asphalt hardener.

The inventive concepts taught by way of the examples discussed above are amenable to modification, rearrangement, and embodiment in several ways. Accordingly, although the present disclosure has been described with reference to specific embodiments and examples, persons skilled in the art will recognize that changes may be made in form and detail without departing from the spirit and scope of the disclosure.

An interpretation under 35 U.S.C. § 112(f) is desired only where this description and/or the claims use specific terminology historically recognized to invoke the benefit of interpretation, such as “means,” and the structure corresponding to a recited function, to include the equivalents thereof, as permitted to the fullest extent of the law and this written description, may include the disclosure, the accompanying claims, and the drawings, as they would be understood by one of skill in the art.

To the extent the subject matter has been described in language specific to structural features and/or methodological steps, it is to be understood that the subject matter defined in the appended claims is not necessarily limited to the specific features or steps described. Rather, the specific features and steps are disclosed as example forms of implementing the claimed subject matter. To the extent headings are used, they are provided for the convenience of the reader and are not to be taken as limiting or restricting the systems, techniques, approaches, methods, devices to those appearing in any section. Rather, the teachings and disclosures herein can be combined, rearranged, with other portions of this disclosure and the knowledge of one of ordinary skill in the art. It is the intention of this disclosure to encompass and include such variation.

The indication of any elements or steps as “optional” does not indicate that all other or any other elements or steps are mandatory. The claims define the invention and form part of the specification. Limitations from the written description are not to be read into the claims.

Unless explicitly stated otherwise, each numerical value and range should be interpreted as being approximate as if the word “about” or “approximately” preceded the value or range.

Unless otherwise indicated, all numbers expressing quantities of ingredients, properties such as molecular weight, percent, ratio, reaction conditions, and so forth used in the specification and claims are to be understood as being modified in all instances by the term “about,” whether or not the term “about” is present. Accordingly, unless indicated to the contrary, the numerical parameters set forth in the specification and claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements.

It will be further understood that various changes in the details, materials, and arrangements of the parts which have been described and illustrated in order to explain embodiments of this invention may be made by those skilled in the art without departing from embodiments of the invention encompassed by the following claims.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

All documents mentioned herein are hereby incorporated by reference in their entirety or alternatively to provide the disclosure for which they were specifically relied upon.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

What is claimed is:

1. A cold mix asphalt composition comprising:
an aggregate blend including an aggregate and a filler; and
a cold mix asphalt binder including a urethane-modified asphalt binder mixed with the aggregate blend to form the cold mix asphalt composition.

2. The cold mix asphalt composition of claim 1,
wherein the urethane-modified asphalt binder comprises Blackhawk 5700 (BH5700) asphalt-modified polyurethane.

3. The cold mix asphalt composition of claim 1,
wherein the urethane-modified asphalt binder and the aggregate blend are mixed to form a two-part binder and aggregate blend, including a Part A portion as a first portion of the two-part binder to be mixed with the aggregate blend initially and a Part B portion as a second portion of the two-part binder to be mixed with an initial mixture of the Part A portion and the aggregate blend subsequently.

4. The cold mix asphalt composition of claim 3,
wherein the Part A portion and the aggregate blend are mixed to form a shelf stable mixture in preset proportions between the Part A portion and the aggregate blend to yield a quantity to be stored.

5. The cold mix asphalt composition of claim 4,
wherein the Part A portion is about 1-10% by a total weight of the quantity and the aggregate blend is about 90-99% by the total weight.

6. The cold mix asphalt composition of claim 3,
wherein the Part B portion comprises a Part B activator dosed at approximately 2-5% by a total weight of both the Part A portion and the Part B portion combined, and the Part A portion comprises a Part A binder dosed at approximately 95-98% by the total weight.

7. A method of producing a cold mix asphalt, the method comprising:
mixing an aggregate blend, including an aggregate and a filler, and a cold mix asphalt binder including a urethane-modified asphalt binder to form a cold mix asphalt composition;
applying the cold mix asphalt composition to a surface; and
compacting the cold mix asphalt composition.

8. The method of claim 7, wherein the urethane-modified asphalt binder includes a two-part binder comprising a Part A portion as a first portion of the two-part binder and a Part B portion as a second portion of the two-part binder, wherein mixing the aggregate blend and the cold mix asphalt binder comprises:
mixing the aggregate blend and the Part A portion of the two-part binder initially to form an initial mixture; and
mixing the initial mixture and the Part B portion of the two-part binder subsequently to form the cold mix asphalt composition.

9. The method of claim 8,
wherein the initial mixture is formed by mixing the Part A portion off-site away from a location of the surface for applying and compacting the cold mix asphalt composition; and
wherein the cold mix asphalt composition is formed by mixing the Part B portion on-site at the location of the surface for applying and compacting the cold mix asphalt composition.

10. The method of claim 8,
wherein the initial mixture is formed by mixing the Part A portion at about 1 to 10% by a total weight of the initial mixture of the Part A portion and the aggregate blend.

11. The method of claim 10,
wherein the cold mix asphalt composition is formed by mixing the Part B portion at about 2 to 5% by a total weight of the cold mix asphalt binder including the Part A portion and the Part B portion.

12. The method of claim 8,
wherein the cold mix asphalt composition is formed by mixing the Part B portion at about 2 to 5% by a total weight of the cold mix asphalt binder including the Part A portion and the Part B portion.

13. The method of claim 8, further comprising:
wherein the initial mixture is formed by mixing the Part A portion with the aggregate blend for about 3-4 minutes; and
wherein the cold mix asphalt composition is formed by mixing the Part B portion with the initial mixture for at least about 3 minutes.

14. The method of claim 7, further comprising:
wherein the urethane-modified asphalt binder comprises Blackhawk 5700 (BH5700) asphalt-modified polyurethane.

15. A cold mix asphalt composition comprising:
an aggregate blend including an aggregate and a filler; and
a two-part binder mixed with the aggregate blend to form the cold mix asphalt composition, the two-part binder including a urethane-modified asphalt binder as a Part A binder to be mixed with the aggregate blend to form an initial mixture, and an asphalt-modified polyurethane as a Part B activator to be mixed with the initial mixture to form the cold mix asphalt composition.

16. The cold mix asphalt composition of claim 15,
wherein the Part A binder and the aggregate blend are mixed to form a shelf stable mixture; and
wherein the Part B activator is mixed with the shelf stable mixture subsequently to form the cold mix asphalt composition.

17. The cold mix asphalt composition of claim 16,
wherein the Part A binder is about 1-10% by a total weight of the shelf stable mixture and the aggregate blend is about 90-99% by the total weight of the shelf stable mixture.

18. The cold mix asphalt composition of claim 17,
wherein the Part A binder is dosed at approximately 95 to 98% by a total weight of the Part A binder and the Part B activator, and the Part B activator is dosed at approximately 2 to 5% by the total weight of the Part A binder and the Part B activator.

19. The cold mix asphalt composition of claim 15,
wherein the urethane-modified asphalt binder is the asphalt-modified polyurethane; and
wherein the Part A binder and the Part B activator are preset proportions of the asphalt-modified polyurethane.

20. The cold mix asphalt composition of claim 19,
wherein the Part A binder is dosed at approximately 95 to 98% by a total weight of the Part A binder and the Part B activator, and the Part B activator is dosed at approximately 2 to 5% by the total weight of the Part A binder and the Part B activator.
